(19) United States
(12) Patent Application Publication
(10) Pub. No.: US 2026/0331578 A1
(43) Pub. Date: Oct. 22, 2026

(54) POLYMER ELECTROLYTE AND SECONDARY BATTERY

(71) Applicant: CANON KABUSHIKI KAISHA, Tokyo (JP)

(72) Inventors: SOUYA YAMANE, Shizuoka (JP); HIROAKI KOMATSU, Shizuoka (JP); HIDEYA ARIMURA, Shizuoka (JP); KENTA MATSUNAGA, Shizuoka (JP); MASAKI YAMADA, Shizuoka (JP)

(21) Appl. No.: 19/467,115

(22) Filed: Feb. 2, 2026

Related U.S. Application Data
(63) Continuation of application No. PCT/JP2024/027584, filed on Aug. 1, 2024.

(30) Foreign Application Priority Data
Aug. 4, 2023 (JP) 2023-127680
Jun. 21, 2024 (JP) 2024-100598
Jul. 10, 2024 (JP) 2024-110667

(51) Int. Cl. H01M 10/0565; H01M 4/62

(52) U.S. Cl. CPC H01M 10/0565; H01M 4/622; H01M 2300/0082

(57) ABSTRACT

A polymer electrolyte exhibits high mechanical strength even at high temperatures, and high ionic conductivity, and can minimize the occurrence of dendrites at the interface between a polymer electrolyte and a battery negative electrode. The polymer electrolyte contains a polymer having a specific free terminal polyether structure, a specific polyether cross-linked structure, and a specific fluorine sulfonylimide anionic group, the polymer electrolyte contains a specific amount of a specific alkali metal salt, and the volume swelling ratio of the polymer electrolyte determined by a methyl ethyl ketone immersion method is 30% to 120%.

### CROSS-REFERENCE TO RELATED APPLICATIONS

This application is a Continuation of International Patent Application No. PCT/JP2024/027584, filed Aug. 1, 2024, which claims the benefit of Japanese Patent Application No. 2024-110667, filed Jul. 10, 2024, Japanese Patent Application No. 2024-100598, filed Jun. 21, 2024, and Japanese Patent Application No. 2023-127680, filed Aug. 4, 2023 all of which are hereby incorporated by reference herein in their entirety.

### BACKGROUND

### Field of the Technology

The present disclosure relates to a polymer electrolyte and a secondary battery.

### Description of the Related Art

In recent years, with the development of portable devices such as tablet terminals and smartphones, and electric vehicles, there has been an increasing demand for secondary batteries as their power sources. Generally, secondary batteries are composed of electrodes (a positive electrode and a negative electrode) and an electrolyte, and are charged and discharged when ions move between the electrodes with the electrolyte therebetween. Such secondary batteries are used in a wide range of applications from small devices such as mobile phones to large devices such as electric vehicles. Therefore, higher safety and further performance improvements are required.

In order to further improve the safety of secondary batteries, the development of solid-state secondary batteries in which conventional combustible electrolytic solutions are replaced with solid electrolytes is underway. As solid electrolytes, sulfide-based, oxide-based, and polymer-based materials are widely studied.

In order to improve charging and discharging characteristics of secondary batteries, generally, it is important to enlarge the interface between the active material in the electrodes and the electrolyte. Here, the active material is a substance that participates in the reaction that generates electricity. While sulfide-based and oxide-based solid electrolytes have excellent ionic conductivity, it is difficult to enlarge the interface with the active material, and they may not have sufficient impact resistance. Therefore, the use of flexible solid electrolytes such as gel electrolytes in which electrolytic solutions and polymers are combined has been proposed.

Japanese Patent Laid-Open No. 2017-090677 describes a gel electrolyte containing a polyether and an ionic liquid. In addition, WO 2004/027789 describes a gel electrolyte in which affinity with an electrolytic solution is improved by incorporating a quaternary ammonium base into the main chain. In addition, Japanese Patent Laid-Open No. 2009-104891 describes a dry polymer electrolyte containing a glyme and a lithium salt.

### SUMMARY

In recent years, lithium-ion secondary batteries have been required to exhibit not only higher safety but also further improved charging and discharging characteristics. When a polymer gel such as those in Japanese Patent Laid-Open No. 2017-090677 and WO 2004/027789 is used as an electrolyte, the strength at high temperatures may decrease, and there may be a risk of short-circuiting occurring due to impact. In addition, in the dry polymer system in Japanese Patent Laid-Open No. 2009-104891, in order to exhibit high ionic conductivity, it is necessary to form a lithium ion complex with a glyme, which is an organic solvent. It is known that lithium salts coordinated with a glyme form ionic liquids and inherently have the same issues as liquid electrolytes.

In addition, in secondary batteries, dendrites occur at the interface between the electrolyte and the metal negative electrode, which can cause a shortened cycle life. Among negative electrode materials for secondary batteries, “metal negative electrodes” have the highest charge capacity density and their practical applications are expected to improve energy density. Since the use of metal negative electrodes is considered to significantly improve performance of the secondary batteries, it is important to minimize the occurrence of dendrites. In addition, if dendrite growth progresses, there is a risk of damaging base materials and packaging materials constituting batteries, raising safety concerns.

Therefore, there are demands for polymer electrolytes that:
minimize a decrease in impact resistance even at high temperatures and the risk of short-circuiting,
exhibit excellent ionic conductivity, and
have a long cycle life.

At least one aspect of the present disclosure provides a polymer electrolyte which exhibits high mechanical strength even at high temperatures, and high ionic conductivity, and can minimize the occurrence of dendrites at the interface between a polymer electrolyte and a battery negative electrode. In addition, at least one aspect of the present disclosure provides a secondary battery having high impact resistance even in a high temperature environment and excellent battery performance.

According to at least one aspect of the present disclosure, provided is a polymer electrolyte, wherein the polymer electrolyte contains a polymer and an alkali metal salt, the alkali metal salt includes an alkali metal salt containing, as an anion, at least one selected from the group consisting of bis(trifluoromethanesulfonyl)imide, bis(fluorosulfonyl)imide and hexafluorophosphate, the polymer has a structure represented by the following Formula (1), at least one structure selected from the group consisting of a structure represented by the following Formula (2) and a structure represented by the following Formula (3), and a structure represented by the following Formula (4), when the total number of moles of the anions in the alkali metal salt contained per unit mass of the polymer electrolyte is A, and the number of moles of sulfonylimide groups bonded to the polymer is B, A and B satisfy the relationship of the following Formula (X), 0.50≤A/(A+B) . . . (X) and the volume swelling ratio of the polymer electrolyte determined by a methyl ethyl ketone immersion method is 30% to 120%:

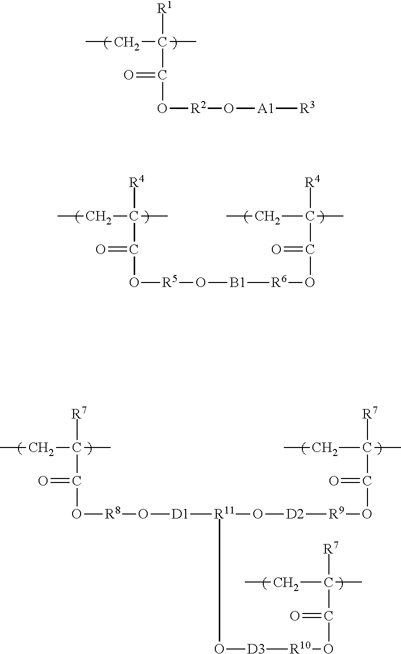

(In Formula (1), R¹ is a hydrogen atom or a methyl group. R² is a linear or branched alkylene group having 1 to 6 carbon atoms. R³ is an alkyl group having 1 to 6 carbon atoms. In Formula (2), R⁴'s are each independently a hydrogen atom or a methyl group. R⁵ and R⁶ are each independently a linear or branched alkylene group having 1 to 6 carbon atoms. In Formula (3), R⁷'s are each independently a hydrogen atom or a methyl group. R¹, R⁹ and R¹⁰ are each independently a linear or branched alkylene group having 1 to 6 carbon atoms. R¹¹ is a trivalent organic group having 1 to 6 carbon atoms. In Formulae (1) to (3), A1, B1, D1, D2 and D3 are each independently a linking group having at least an ethylene oxide structure represented by (—CH₂CH₂—O—).)

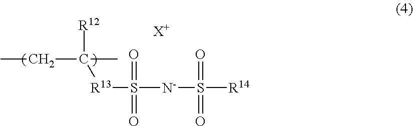

(In Formula (4), R¹² is a hydrogen atom or a methyl group, R¹³ is a divalent linking group, R¹⁴ is a fluorine atom or a perfluoroalkyl group having 1 to 4 carbon atoms. X⁺ is at least one selected from the group consisting of a lithium ion, a sodium ion and a potassium ion. The sulfonylimide group is a functional group represented by the following Formula (S).

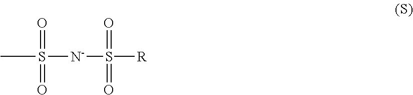

In Formula (S), R is a fluorine atom or a perfluoroalkyl group having 1 to 4 carbon atoms.

In addition, according to at least one aspect of the present disclosure, a secondary battery, including a positive electrode, a bulk electrolyte and a negative electrode, wherein at least one selected from the group consisting of the positive electrode, the bulk electrolyte and the negative electrode contains the polymer electrolyte is provided.

Features of the present disclosure will become apparent from the following description of embodiments with reference to the attached drawings.

### BRIEF DESCRIPTION OF THE DRAWINGS

FIG. 1 is a schematic cross-sectional view of a secondary battery using a polymer electrolyte of the present disclosure as a bulk electrolyte.

FIG. 2 is a schematic cross-sectional view of a secondary battery using the polymer electrolyte of the present disclosure as a positive electrode active material binder.

FIG. 3 is a schematic cross-sectional view of a secondary battery using the polymer electrolyte of the present disclosure as a positive electrode active material binder, a bulk electrolyte, and a negative electrode active material binder.

### DESCRIPTION OF THE EMBODIMENTS

In the present disclosure, unless otherwise specified, the descriptions “from XX to YY” and “XX to YY” representing a numerical range mean a numerical range including a lower limit and an upper limit which are end points. In addition, when the numerical ranges are expressed in stages, the upper limits and lower limits of the numerical ranges can be arbitrarily combined. In addition, in the present disclosure, for example, the description such as “at least one selected from the group consisting of XX, YY and ZZ” means any of XX, YY, ZZ, a combination of XX and YY, a combination of XX and ZZ, a combination of YY and ZZ, and a combination of XX, YY and ZZ. Here, when XX is a group, a plurality of XXs may be selected, and the same applies to YY and ZZ.

The inventors conducted extensive studies to obtain a polymer electrolyte that exhibits high mechanical strength even at high temperatures and high ionic conductivity, and minimizes the occurrence of dendrites at the interface between the polymer electrolyte and a battery negative electrode.

First, the inventors found that, in dry polymer systems in which promotion of lithium ion movement by a liquid electrolyte cannot be expected, the ionic conductivity can be increased by using a polyether-modified (meth)acrylic resin having a specific 3D cross-linked structure.

Thus, the inventors conducted further studies on the polyether-modified (meth)acrylic resin. As a result, they found that, when an anionic functional group having at least one selected from the group consisting of a fluorosulfonylimide (FSI) group and a perfluoroalkylsulfonylimide (PFSI) group is bonded to the molecular chain of the polyether-modified (meth)acrylic resin and a specific cation X⁺ is combined as a counter ions (cation) of the anionic functional group, it is possible to obtain a polymer electrolyte that can achieve a high ionic conductivity and transport number of the specific cations even at low temperatures.

That is, the polymer electrolyte of the present disclosure satisfies the following conditions.
The 3D cross-linked structure of the polymer has many free terminal chains with one end not bonded to another polymer chain (the structure of Formula (1)), resulting in a very low crosslink density (volume swelling ratio)
The 3D cross-linked structure of the polymer contains an anionic functional group having a fluorinated sulfonylimide group or a perfluoroalkylsulfonylimide group and a cation (the structures of Formula (2) and/or Formula (3), and the structure of Formula (4))

In addition, the polymer electrolyte contains a polymer having the anionic functional group in the molecule and an alkali metal salt which is an electrolyte (supporting electrolyte) that is not fixed to the polymer at a specific ratio (Formula (X)). Therefore, it is possible to minimize the occurrence of dendrites.

The inventors speculate the reason why the polymer electrolyte according to one aspect of the present disclosure exhibits high ionic conductivity without relying on a liquid electrolyte to be as follows.

In dry polymer systems in which stabilization of ions such as lithium ions by a liquid electrolyte is not feasible, the ions move between molecularly mobile polymer chains. Therefore, polymer systems that are three-dimensionally crosslinked to minimize the risk of short-circuiting due to film deformation in a high temperature range are more susceptible to steric hindrance compared to liquid systems.

However, the polymer used in the present disclosure has a 3D cross-linked structure (the structures of Formula (2) and/or Formula (3)) and is less likely to deform even at high temperatures. On the other hand, the polymer has, in its structure, a free terminal chain (the structure of Formula (1)) with one end not bonded to another polymer chain. Accordingly, it is thought that the polymer does not form a dense network structure, and makes it less likely to inhibit ion movement while maintaining its strength.

In addition, the fluorosulfonylimide structure or perfluoroalkylsulfonylimide structure bonded to the polymer makes it less likely to inhibit ion movement and makes it possible to provide an electrolyte with a high ion transport number.

In addition, the fluorosulfonylimide structure or perfluoroalkylsulfonylimide structure bonded to the polymer minimizes stereoregularity and reduces polymer crystallinity. Therefore, it is thought that a decrease in ionic conductivity at low temperatures is also minimized.

In addition, the anionic group having a fluorosulfonylimide structure or perfluoroalkylsulfonylimide structure bonded to the polymer and a cation (the structure of Formula (4)) make the polymer highly polar. Therefore, even in systems in which a supporting electrolyte such as a lithium salt is added, the supporting electrolyte is not precipitated, and the amount of the supporting electrolyte that can be dissolved can be increased.

In addition, by using an alkali metal salt as a supporting electrolyte in combination, it is possible to minimize a local increase in concentration of ions such as lithium ions near the metal negative electrode. This is thought to be because free anions having a higher degree of dissociation than immobilized anions move through the polymer, and thus minimize the interaction between the immobilized anionic groups and the ions, and level the ion concentration distribution. Particularly, when free anions are present in a range that satisfies the following Formula (X): 0.50≤A/(A+B), it is possible to minimize ion localization.

The dendrite growth is caused by local aggregation of ions such as lithium ions in the electrolyte. Therefore, delocalization of the ion distribution can lead to minimization of the occurrence of dendrites and extension of the cycle life of the secondary battery. The polymer used in the present disclosure is designed to have a very low crosslink density, which allows free anions to move easily. The ease of movement of free anions is thought to make the effect of delocalizing the ion distribution appear more significantly.

The 3D cross-linked structure of the polymer has many free terminal chains with one end not bonded to another polymer chain, resulting in a very low crosslink density, which is prominently reflected in the volume swelling ratio of the polymer electrolyte determined by a methyl ethyl ketone immersion method. Specifically, the volume swelling ratio of the polymer electrolyte using methyl ethyl ketone (MEK) is 30% to 120%.

The volume swelling ratio is the ratio of the volumes of a 3D crosslinked polymer before and after it is immersed in a specific solvent and swelling with the solvent has reached saturation. The volume swelling ratio is calculated using the following formula, and the volume of a test specimen is calculated from the weight in air and the weight in water. Specific measurement procedures will be described below.

Volume swelling ratio (%)=(volume when saturated by immersion in solvent and swelling)/(volume before immersion in solvent)×100

When the volume swelling ratio of the polymer electrolyte is less than 30%, it is thought that there are few free terminal chains (the structure of Formula (1)) and many 3D cross-linked structures. Therefore, the ionic conductivity is low and the rate characteristic of the secondary battery is likely to be low. In addition, since there are many 3D cross-linked structures, it is difficult to obtain the effect of delocalizing the ion distribution, and dendrites occur.

On the other hand, when the volume swelling ratio of the polymer electrolyte is more than 120%, it indicates that the number of 3D cross-linked structures is insufficient so that a decrease in strength such as a decrease in impact resistance at high temperatures is likely to occur.

The volume swelling ratio of the polymer electrolyte is preferably 40% to 120%, more preferably 60% to 110%, and still more preferably 70% to 105%.

Preferable embodiments of the present disclosure will be described in detail below with reference to the drawings. The components, materials, shapes, relative arrangements thereof and the like described in these embodiments do not limit the scope of the present disclosure.

### (1) Form of Secondary Battery

The secondary battery includes a positive electrode, a bulk electrolyte and a negative electrode, and at least one of the positive electrode, the bulk electrolyte and the negative electrode contains the polymer electrolyte of the present disclosure. For example, the bulk electrolyte is a polymer electrolyte.

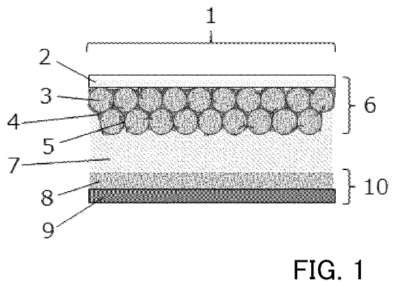

FIG. 1 to FIG. 3 show an example of a secondary battery using the polymer electrolyte of the present disclosure. A secondary battery 1 shown in FIG. 1 shows a schematic configuration example of a secondary battery using a polymer electrolyte as a bulk electrolyte 7. A positive electrode active material 3 provided on a positive electrode current collector 2 is fixed by a positive electrode active material binder 4 to form a positive electrode 6. The positive electrode 6 may contain a conductivity aid 5.

A negative electrode active material 8 provided on a negative electrode current collector 9 forms a negative electrode 10. In FIG. 1, the negative electrode active material is metallic lithium, indium or the like. The bulk electrolyte 7 is provided between the positive electrode 6 and the negative electrode 10.

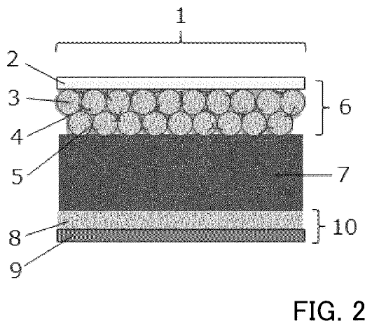

The secondary battery 1 shown FIG. 2 shows a schematic configuration example of a secondary battery using a polymer electrolyte as the positive electrode active material binder 4. In the aspect of FIG. 2, the positive electrode 6 contains a polymer electrolyte. For example, the positive electrode 6 contains the positive electrode active material 3 and the positive electrode active material binder 4 that fixes the positive electrode active material, and the positive electrode active material binder 4 is the polymer electrolyte of the present disclosure. In the configuration in FIG. 2, the bulk electrolyte 7 is an oxide-based or sulfide-based inorganic solid electrolyte. The other configurations are the same as those in FIG. 1.

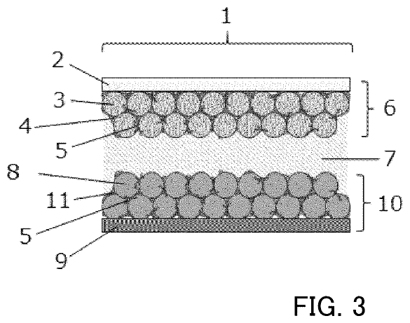

The secondary battery 1 shown in FIG. 3 shows a schematic configuration example of a secondary battery using a polymer electrolyte as the positive electrode active material binder 4, the bulk electrolyte 7, and a negative electrode active material binder 11. In the aspect of FIG. 3, the positive electrode, the bulk electrolyte and the negative electrode contain a polymer electrolyte. That is, the positive electrode 6 contains the positive electrode active material 3 and the positive electrode active material binder 4 that fixes the positive electrode active material, and the positive electrode active material binder 4 is the polymer electrolyte of the present disclosure. In addition, the bulk electrolyte 7 is the polymer electrolyte of the present disclosure. In addition, the negative electrode 10 contains the negative electrode active material 8 and the negative electrode active material binder 11 that fixes the negative electrode active material 8, and the negative electrode active material binder 11 is the polymer electrolyte of the present disclosure. In the configuration of FIG. 3, the negative electrode active material 8 is a carbon material such as graphite. The other configurations are the same as those in FIG. 1.

In order to achieve more effectively the effects of the present disclosure, as shown in FIG. 1 and FIG. 3, it is preferable that the bulk electrolyte 7 be a polymer electrolyte, penetrating into the positive electrode active material 3 and the negative electrode active material 8, resulting in an increase in contact area.

### Method of Producing Solid-State Secondary Battery

The solid-state secondary battery can be produced by known cell forming techniques such as forming of a laminate cell type, a coin cell type, and a pressurized cell type. A laminate cell type will be exemplified below.

A laminate in which a positive electrode, a bulk electrolyte, and a negative electrode are disposed between a positive electrode current collector and a negative electrode current collector is obtained. Electrode tabs are welded to the positive electrode and the negative electrode current collector. The laminate in which the positive electrode current collector, the positive electrode, the bulk electrolyte, the negative electrode, and the negative electrode current collector are laminated in that order is wrapped with an aluminum laminate film, and sealed under a reduced pressure using a vacuum packaging machine. When the ends of the electrode tabs are exposed outside the laminate film, and the tabs and the aluminum laminate film are bonded by thermocompression bonding, sealing is performed. After sealing, as necessary, pressurization may be performed using an isostatic pressurizing device or the like. Examples of bulk electrolytes include a solid electrolyte and a polymer electrolyte, but both may be used to form a laminate. In addition to the above laminate, other layers such as an elastic material and a resin material may be laminated within the aluminum laminate film in consideration of strength and molding. In addition, a bipolar type in which a plurality of laminates are laminated may be used.

### Positive Electrode Current Collector

Examples of positive electrode current collectors include metal foils. Examples of metals include aluminum, stainless steel, copper, silver, gold, platinum, nickel, and palladium. The metals may be used alone or two or more thereof may be used in combination.

### Positive Electrode Active Material

As the positive electrode active material, for example, those commonly used in secondary batteries such as a lithium-ion secondary battery can be used. Examples thereof include (CF)ₘ, (C₂F)ₘ, MnO₂, TiS₂, MoS₂, FeS₂, Li_{xA}CoO₂, Li_{xA}NiO₂, Li_{xA}MnO₂, Li_{xA}Co_{y}Ni_{1-y}O₂, Li_{xA}Co_{y}M_{1-y}O_{z}, Li_{xA}Ni_{1-y}M_{y}O_{z}, Li_{xB}Mn₂O₄, Li_{xB}Mn_{2-y}M_{y}O₄ (in the formulae, M is at least one selected from the group consisting of Na, Mg, Sc, Y, Mn, Fe, Co, Ni, Cu, Zn, Al, Cr, Pb, Sb and B, xA=0 to 1.2, xB=0 to 2.0, y=0 to 0.9, and z=2.0 to 2.3), vanadium oxide and lithium compounds thereof, niobium oxide and lithium compounds thereof, conjugated polymers using organic conductive substances, and olivine compounds.

Here, the xA value and xB value in the above composition ratios are values before charging and discharging start, and increase or decrease according to charging and discharging. The positive electrode active materials can be used alone or two or more thereof can be used in combination.

### Conductivity Aid

As the conductivity aid, for example, those commonly used in secondary batteries such as a lithium-ion secondary battery can be used. Examples thereof include graphites such as natural graphite and artificial graphite, carbon blacks such as acetylene black, ketjen black, channel black, furnace black, lamp black, and thermal black, conductive fibers such as carbon fibers and metal fibers, metal powders such as aluminum powder, conductive whiskers such as zinc oxide whiskers and potassium titanate whiskers, conductive metal oxides such as titanium dioxide, and organic conductive materials such as phenylene derivatives. The conductivity aids can be used alone or two or more thereof can be used in combination.

### Active Material Binder

As the active material binder, for example, those commonly used in secondary batteries such as a lithium-ion secondary battery can be used. Examples thereof include polyvinylidene fluoride (PVDF), polytetrafluoroethylene, polyethylene, polypropylene, aramid resin, polyamide, polyimide, polyamideimide, polyacrylonitrile, polyacrylic acid, polymethyl acrylate, polyethyl acrylate, polyhexyl acrylate, polymethacrylic acid, polymethyl methacrylate, polyethyl methacrylate, polyhexyl methacrylate, polyvinyl acetate, polyvinylpyrrolidone, polyether, polyethersulfone, hexafluoropolypropylene, styrene butadiene rubber, and carboxymethyl cellulose.

The polymer electrolyte of the present disclosure may be used as a bulk electrolyte, may be used as a positive electrode active material binder, or may be used as a negative electrode active material binder, or may be used as a bulk electrolyte, a positive electrode active material binder and a negative electrode active material binder.

That is, the secondary battery preferably satisfies at least one of the following (i) to (iii).
(i) The positive electrode 6 contains the positive electrode active material 3 and the positive electrode active material binder 4 that fixes the positive electrode active material, and the positive electrode active material binder 4 is the polymer electrolyte of the present disclosure.
(ii) The bulk electrolyte 7 is the polymer electrolyte of the present disclosure.
(iii) The negative electrode 10 contains the negative electrode active material 8 and the negative electrode active material binder 11 that fixes the negative electrode active material 8, and the negative electrode active material binder 11 is the polymer electrolyte of the present disclosure.

When the polymer electrolyte of the present disclosure is used as the positive electrode active material binder, this is particularly preferable because lithium ions can easily reach from the surface to the deep part of the positive electrode 6. The active material binders may be used alone or two or more thereof may be used in combination.

The positive electrode 6 can be produced, for example, by press-bonding a positive electrode mixture onto the surface of the positive electrode current collector 2 or by applying a positive electrode mixture slurry, performing drying, and additionally performing rolling as necessary to form the positive electrode 6. In addition, it can also be prepared by kneading the positive electrode active material, the conductivity aid and the positive electrode active material binder. The positive electrode mixture slurry can also be prepared, for example, by dissolving or dispersing the positive electrode active material, the conductivity aid and the active material binder in a medium such as dehydrated N-methyl-2-pyrrolidone, acetonitrile, methyl ethyl ketone, or ethylene glycol ethers.

### Negative Electrode Current Collector

Examples of negative electrode current collectors include metal foils. Examples of metals include aluminum, stainless steel, copper, silver, gold, platinum, nickel, and palladium. The metals may be used alone or two or more thereof may be used in combination.

### Negative Electrode Active Material

Examples of negative electrode active materials include metals, metal fibers, carbon materials, oxides, nitrides, silicon, silicon compounds, tin, tin compounds, and various alloy materials. Among these, in consideration of the capacity density, metals, oxides, carbon materials, silicon, silicon compounds, tin, tin compounds and the like are preferable.

Examples of metals include metallic Li and In—Li, and examples of oxides include Li₄Ti₅O₁₂ (LTO: lithium titanate). Examples of carbon materials include various natural graphites (graphite), coke, partially graphitized carbon, carbon fibers, spherical carbon, various artificial graphites, and amorphous carbon. Examples of silicon compounds include silicon-containing alloys, silicon-containing inorganic compounds, silicon-containing organic compounds, and solid solutions. Examples of tin compounds include SnO_{B} (0<B<2), SnO₂, SnSiO₃, Ni₂Sn₄, and Mg₂Sn.

In addition, the negative electrode material may contain a conductivity aid. Examples of conductivity aids include graphites such as natural graphite and artificial graphite, and carbon black such as acetylene black, ketjen black, channel black, furnace black, lamp black, and thermal black. When the polymer electrolyte is used as the bulk electrolyte, graphite can be particularly preferably used as the negative electrode active material.

Examples of conductivity aids include conductive fibers such as carbon fibers, carbon nanotubes, and metal fibers, metal powders such as fluorocarbon and aluminum, conductive whiskers such as zinc oxide, conductive metal oxides such as titanium dioxide, and organic conductive materials such as phenylene dielectrics.

### Solid Electrolyte

In the secondary battery, the solid electrolyte is disposed between the positive electrode and the negative electrode as a lithium ion movement layer, and may be used as a bulk electrolyte that also functions as a separator. In addition, it can also be used as an auxiliary agent that improves conductivity of lithium ions by being mixed into the active material layers of the positive electrode and the negative electrode.

The polymer electrolyte of the present disclosure can be suitably used as both a bulk electrolyte and an auxiliary material. Accordingly, it is possible to enlarge the contact interface between the bulk electrolyte, and the positive electrode and the negative electrode active material, it also provides flexibility that allows it to conform to expansion and contraction of the positive electrode and the negative electrode active material, and thus it is possible to improve characteristics of the secondary battery.

In addition, when the polymer electrolyte of the present disclosure is used as the bulk electrolyte, it is easier to exhibit the effect of minimizing the occurrence of dendrites. Therefore, the bulk electrolyte is preferably the polymer electrolyte of the present disclosure.

For the bulk electrolyte and the auxiliary material, a solid electrolyte other than the polymer electrolyte may be used. Examples of solid electrolytes other than the polymer electrolyte include oxide-based solid electrolytes, sulfide-based solid electrolytes, and complex hydride-based solid electrolytes.

Examples of oxide-based solid electrolytes include nasicon-type compounds such as Li_{1.5}Al_{0.5}Ge_{1.5}(PO₄)₃ and Li_{1.3}Al_{0.3}Ti_{1.7}(PO₄)₃, and garnet-type compounds such as Li_{6.25}LA₃ZR₂Al_{0.25}O₁₂. In addition, examples of oxide-based solid electrolytes include perovskite-type compounds such as Li_{0.33}La_{0.55}TiO₃. In addition, examples of oxide-based solid electrolytes include lisicon-type compounds such as Li₁₄Zn(GeO₄)₄, and acid compounds such as Li₃PO₄, Li₄SiO₄, and Li₃BO₃. Specific examples of sulfide-based solid electrolytes include Li₂S—SiS₂, LiI—Li₂S—SiS₂, LiI—Li₂S—P₂S₅, LiI—Li₂S—P₂O₅, LiI—Li₃PO₄—P₂S₅, and Li₂S—P₂S₅.

In addition, the solid electrolyte may be crystalline or amorphous, or may be a glass ceramic. Here, the term Li₂S—P₂S₅ refers to a sulfide-based solid electrolyte formed using a raw material containing Li₂S and P₂S₅.

The polymer electrolyte of the present disclosure can be used as a bulk electrolyte, a positive electrode active material binder, or a negative electrode active material binder. The configuration of the polymer electrolyte according to one embodiment of the present disclosure will be described below in detail.

The polymer electrolyte of the present disclosure is preferably, for example, a solid electrolyte or a semi-solid electrolyte, such as a dry polymer electrolyte or a gel electrolyte. That is, a non-liquid electrolyte is preferable. A dry polymer electrolyte is more preferable. The polymer electrolyte is preferably substantially free of a liquid component such as a liquid electrolyte.

### Polymer Electrolyte

A polymer electrolyte according to one embodiment of the present disclosure includes a polymer having the following structure. The polymer is, for example, a (meth)acrylic polymer. The polymer electrolyte is, for example, a polyether acrylic resin having a 3D cross-linked structure including the following structure.
A structure represented by Formula (1)
At least one structure selected from the group consisting of a structure represented by Formula (2) and a structure represented by Formula (3)
A structure represented by Formula (4)

The polymer electrolyte has a structure represented by the following Formula (1).

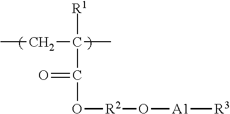

In Formula (1), R¹ is a hydrogen atom or a methyl group. R² is a linear or branched alkylene group having 1 to 6 (preferably 1 to 4 and more preferably 2 to 4) carbon atoms. R³ is an alkyl group having 1 to 6 (preferably 1 to 4 and more preferably 1) carbon atoms.

In Formula (1), A1 is a linking group having at least an ethylene oxide structure represented by (—CH₂CH₂—O—).

The structure represented by Formula (1) is preferably a structure represented by the following Formula (1-1).

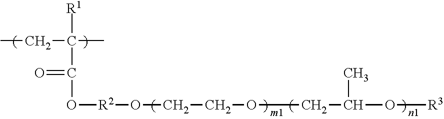

In Formula (1-1), R¹ is a hydrogen atom or a methyl group. R² is a linear or branched alkylene group having 1 to 6 (preferably 1 to 4 and more preferably 2 to 4) carbon atoms. R³ is an alkyl group having 1 to 6 (preferably 1 to 4 and more preferably 1) carbon atoms. m1 and n1 are an average number of moles added. m1 is an integer of 1 or more (preferably 1 to 110 and more preferably 13 to 46). n1 is an integer of 0 or more (preferably 5% to 25% of m1 and more preferably 11% to 25% of m1).

The polymer electrolyte has at least one structure selected from the group consisting of a structure represented by the following Formula (2) and a structure represented by the following Formula (3). At least one structure selected from the group consisting of a structure represented by Formula (2) and a structure represented by Formula (3) may be a structure represented by Formula (2). With the structure, a 3D cross-linked structure can be formed.

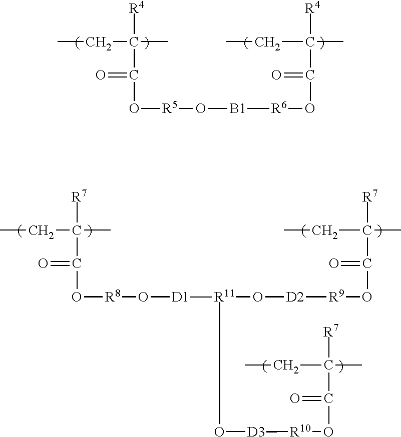

In Formula (2), R⁴'s are each independently a hydrogen atom or a methyl group. R⁵ and R⁶ are each independently a linear or branched alkylene group having 1 to 6 (preferably 1 to 4 and more preferably 2 to 4) carbon atoms.

In Formula (3), R⁷'s are each independently a hydrogen atom or a methyl group. R⁸, R⁹, and R¹⁰ are each independently a linear or branched alkylene group having 1 to 6 (preferably 1 to 4 and more preferably 2 to 4) carbon atoms. R¹¹ is a trivalent organic group having 1 to 6 (preferably 1 to 3 and more preferably 1) carbon atoms.

In Formulae (2) and (3), B1, D1, D2 and D3 are each independently a linking group having at least an ethylene oxide structure represented by (—CH₂CH₂—O—).

In Formulae (1) to (3), preferably, A1, B1, D1, D2 and D3 each independently additionally have a propylene oxide structure represented by (—CH₂CH(CH₃)—O—). The arrangement of the ethylene oxide structure and the propylene oxide structure may be a block copolymer or a random copolymer. A random copolymer is preferable.

In addition, as long as the effects of the present disclosure are not impaired, A1, B1, D1, D2 and D3 may each independently additionally have a diol structure having 1 to 6 (preferably 4 to 6) carbon atoms. The diol structure is represented by —O—R^{x}—O—, where R^{x} is an alkylene group having 1 to 6 (preferably 4 to 6) carbon atoms.

The structure represented by Formula (2) is preferably a structure represented by the following Formula (2-1).

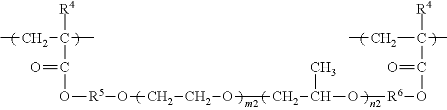

In Formula (2-1), R⁴'s are each independently a hydrogen atom or a methyl group. R⁵ and R⁶ are each independently a linear or branched alkylene group having 1 to 6 (preferably 1 to 4 and more preferably 2 to 4) carbon atoms. m2 and n2 are an average number of moles added, m2 is an integer of 1 or more (preferably 1 to 110 and more preferably 13 to 46), n2 is an integer of 0 or more (preferably 5% to 25% of m2 and more preferably 11% to 25% of m2).

As long as the effects of the present disclosure are not impaired, the chain interposed between two —COO-'s may additionally have a diol structure having 1 to 6 (preferably 4 to 6) carbon atoms. For example, a diol structure maybe provided between ethylene oxide structures, between propylene oxide structures, or between an ethylene oxide structure and a propylene oxide structure. The diol structure is represented by —O—R^{x}—O—, where R^{x} is an alkylene group having 1 to 6 (preferably 4 to 6) carbon atoms.

The structure represented by Formula (3) is preferably a structure represented by the following Formula (3-1).

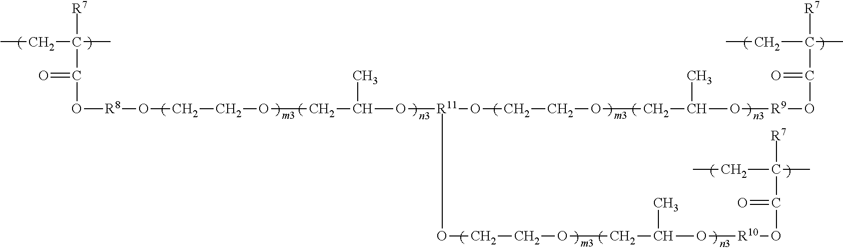

In Formula (3-1), R⁷'s are each independently a hydrogen atom or a methyl group. R⁸, R⁹, and R¹⁰ are each independently a linear or branched alkylene group having 1 to 6 (preferably 1 to 4 and more preferably 2 to 4) carbon atoms. R¹¹ is a trivalent organic group (preferably a hydrocarbon group) having 1 to 6 (preferably 1 to 3 and more preferably 1) carbon atoms. m3 and n3 are an average number of moles added. m3's are each independently an integer of 1 or more (preferably 1 to 110 and more preferably 13 to 46). n3's are each independently an integer of 0 or more (preferably 5% to 25% of m3 and more preferably 11% to 25% of m3).

As long as the effects of the present disclosure are not impaired, the chain interposed between —COO— and R¹¹ may additionally have a diol structure having 1 to 6 (preferably 4 to 6) carbon atoms. For example, a diol structure maybe provided between ethylene oxide structures, between propylene oxide structures, or between an ethylene oxide structure and a propylene oxide structure. The diol structure is represented by —O—R^{x}—O—, where R^{x} is an alkylene group having 1 to 6 (preferably 4 to 6) carbon atoms.

The average number of moles added Meo of ethylene oxide structures per mol of (meth)acryloyl residue in the polymer contained in the polymer electrolyte is preferably 2.5 mol or more. Meo is more preferably 13 to 46. Within the above range, the crosslink density of the polymer main chain becomes more appropriate, and the strength at high temperatures is maintained and high lithium ion conductivity is obtained. The (meth)acryloyl residue is a form in which a (meth)acryloyl group has undergone addition polymerization, and is represented, for example, by the following structure in Formula (1).

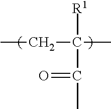

In addition, the average number of moles added Mpo of propylene oxide structures per mol of (meth)acryloyl residue in the polymer contained in the polymer electrolyte is preferably 5% to 25% and more preferably 11% to 25% of the average number of moles added Meo of the ethylene oxide structure per mol of (meth)acryloyl residue. Within the above range, even if the molecular weight between crosslinking points is large, the crystallinity of the polymer main chain is minimized, and it becomes easier to further minimize inhibition of lithium-ion movement particularly at low temperatures can be more effectively inhibited.

The average numbers of moles added Meo and Mpo can be measured by decomposing the polymer electrolyte using pyrolysis GC/MS, and quantifying fragments derived from (meth)acryloyl residues, fragments derived from ethylene oxide structures, and fragments derived from propylene oxide structures using created calibration curves.

The average number of moles added Mpo is preferably 1 to 15, and more preferably 2 to 10.

In the polymer electrolyte of the present disclosure, as described above, the 3D cross-linked structure of the polymer has a very low crosslink density, and the polymer chains have many free chains with one end not bonded to another polymer chain. Such a cross-linked structure can be obtained, for example, by reacting the following materials.
Polyether mono(meth)acrylate
At least one selected from the group consisting of polyether di(meth)acrylate and polyether tri(meth)acrylate
A compound having an unsaturated reactive functional group, an anionic functional group having a fluorinated sulfonylimide group or a perfluoroalkylsulfonylimide group and a cation (hereinafter referred to as a “fluorine sulfonylimide-based ionic compound”)

### Polyether Mono(meth)acrylate

Polyether mono(meth)acrylate can a structure represented by Formula (1) (preferably Formula (1-1)). As the polyether mono(meth)acrylate, for example, at least one selected from the group consisting of polyethylene glycol mono(meth)acrylate, and a mono(meth)acrylate of a polyethylene glycol-propylene glycol copolymer can be used. When a mono(meth)acrylate of a polyethylene glycol-propylene glycol copolymer is used, the molar ratio of the ethylene glycol structure:the propylene glycol structure is preferably 100:0 to 50:50, and more preferably 80:20 to 95:5.

When the molar ratio of the ethylene glycol structure:the propylene glycol structure is within the above range, the lithium-ion transportability provided by polyethylene glycol can be maintained at a high level, and in combination with the structure of Formula (4), it becomes easier to further minimize inhibition of lithium-ion movement due to crystallization of the polymer.

For example, the polyether mono(meth)acrylate is represented by the following Formula (1′).

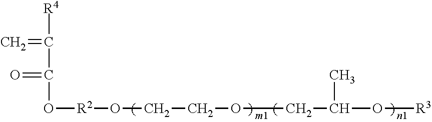

In Formula (1′), R¹, R², R³, m1 and n1 are the same as in Formula (1-1).

### Polyether Di(meth)acrylate

Polyether di(meth)acrylate can form a structure represented by Formula (2) (preferably Formula (2-1)). As the polyether di(meth)acrylate, for example, at least one selected from the group consisting of polyethylene glycol di(meth)acrylate, and a di(meth)acrylate of a polyethylene glycol-propylene glycol copolymer can be used. When a di(meth)acrylate of a polyethylene glycol-propylene glycol copolymer is used, the molar ratio of the ethylene glycol structure: the propylene glycol structure is preferably 100:0 to 50:50, and more preferably 80:20 to 95:5.

When the molar ratio of the ethylene glycol structure:the propylene glycol structure is within the above range, the ion transportability of lithium ions provided by polyethylene glycol can be maintained at a high level, and in combination with the structure of Formula (4), it becomes easier to further minimize inhibition of ion movement of lithium ions due to crystallization of the polymer.

For example, the polyether di(meth)acrylate is represented by the following Formula (2′).

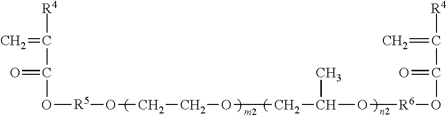

In Formula (2′), R⁴, R⁵, R⁶, m2 and n2 are the same as in Formula (2-1).

As long as the effects of the present disclosure are not impaired, the chain interposed between two —COO-'s may additionally have a diol structure having 1 to 6 (preferably 4 to 6) carbon atoms. For example, a diol structure maybe provided between ethylene oxide structures, between propylene oxide structures, or between an ethylene oxide structure and a propylene oxide structure. The diol structure is represented by —O—R^{x}—O—, where R^{x} is an alkylene group having 1 to 6 (preferably 4 to 6) carbon atoms.

### Polyether Tri(meth)acrylate

Polyether tri(meth)acrylate can form a structure represented by Formula (3) (preferably Formula (3-1)). As the polyether tri(meth)acrylate, for example, at least one selected from the group consisting of polyethylene glycol tri(meth)acrylate, and a tri(meth)acrylate of a polyethylene glycol-propylene glycol copolymer can be used. When a tri(meth)acrylate of a polyethylene glycol-propylene glycol copolymer is used, the molar ratio of the ethylene glycol structure: the propylene glycol structure is preferably 100:0 to 50:50, and more preferably 80:20 to 95:5.

When the molar ratio of the ethylene glycol structure:the propylene glycol structure is within the above range, the ion transportability of lithium ions provided by polyethylene glycol can be maintained at a high level, and in combination with the structure of Formula (4), it becomes easier to further minimize inhibition of ion movement of lithium ions due to crystallization of the polymer.

For example, the polyether tri(meth)acrylate is represented by the following Formula (3′).

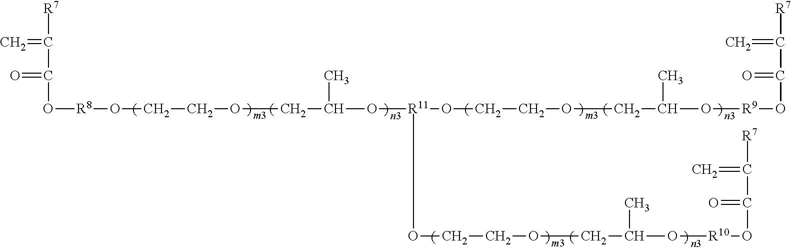

In Formula (3′), R⁷, R⁸, R⁹, R¹⁰, R¹¹, m3 and n3 are the same as in Formula (3-1).

As long as the effects of the present disclosure are not impaired, the chain interposed between —COO— and R¹¹ may additionally have a diol structure having 1 to 6 (preferably 4 to 6) carbon atoms. For example, a diol structure maybe provided between the ethylene oxide structure and the propylene oxide structure. The diol structure is represented by —O—R^{x}—O—, where R^{x} is an alkylene group having 1 to 6 (preferably 4 to 6) carbon atoms.

The structures represented by Formula (1), Formula (2) and Formula (3) (preferably Formula (1-1), Formula (2-1) and Formula (3-1)) can be obtained, for example, using a polyether polyol obtained by ring opening polymerization of ethylene oxide and propylene oxide.

Here, in Formula (1-1), Formula (2-1), and Formula (3-1) (as well as Formula (1′), Formula (2′), and Formula (3′)), the arrangement of an ethylene oxide structure represented by (—CH₂—CH₂—O—) and a propylene oxide structure represented by (—CH₂—CH(CH₃)—O—) may be a block copolymer or a random copolymer. A random copolymer is preferable.

The mass content of the structure represented by Formula (1) in the polymer contained in the polymer electrolyte is α. In addition, the total mass content (preferably the content of the structure represented by Formula (2)) of the structure represented by Formula (2) and the structure represented by Formula (3) in the polymer is β. The mass ratio α:β (α to β) is preferably 70:30 to 98:2. The mass ratio is more preferably 88:12 to 96:4, and still more preferably 90:10 to 95:5.

Specifically, the mass ratio α:β can be adjusted by the ratio between polyether mono(meth)acrylate and polyether di(meth)acrylate and/or tri(meth)acrylate.

When the mass ratio α:β is within the above range, this is particularly preferable because the polymer does not form an excessively dense network structure, and makes it less likely to inhibit lithium-ion movement while maintaining its strength.

In the polymer electrolyte, m1+n1 in Formula (1-1) is 1 to 110 (more preferably 14 to 58), and m2+n2 in Formula (2-1) and/or m3+n3 in Formula (3-1) (preferably m2+n2 and m3+n3) are preferably 1 to 110 (more preferably 14 to 58). Within the above range, since the crosslink density of the polymer main chain becomes appropriate, the strength at high temperatures is maintained, the ionic conductivity of the polymer electrolyte is further improved, and the rate characteristic of the secondary battery also becomes better.

In the polymer electrolyte, m1:n1 in Formula (1-1) is 80:20 to 95:5 (more preferably 80:20 to 90:10), and m2:n2 in Formula (2-1) and/or m3:n3 in Formula (3-1) (preferably m2:n2 in Formula (2-1) and m3:n3 in Formula (3-1)) are preferably 80:20 to 95:5 (more preferably 85:15 to 95:5).

Within the above range, even if the molecular weight between crosslinking points is large, the crystallinity of the polymer main chain is minimized, and it becomes easier to further minimize inhibition of lithium-ion movement particularly at low temperatures.

### Fluorine Sulfonylimide Anionic Group

The polymer in the polymer electrolyte has a structure represented by the following Formula (4).

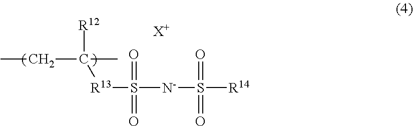

In Formula (4), R¹² is a hydrogen atom or a methyl group. R¹³ is a divalent linking group. R¹⁴ is a fluorine atom or a perfluoroalkyl group having 1 to 4 (preferably 1 or 2) carbon atoms. X⁺ is a cation, and is at least one selected from the group consisting of a lithium ion, a sodium ion and a potassium ion.

The divalent linking group for R¹³ is preferably a linear or branched alkylene group having 1 to 7 (preferably 2 to 4) carbon atoms. The divalent linking group is preferably —COO—R³⁰— (where the carbonyl group is bonded to a carbon atom to which R¹² in Formula (4) is bonded). R³⁰ is preferably a linear or branched alkylene group having 1 to 7 (preferably 2 to 4) carbon atoms.

Regarding the polyether composition of polyether(meth) acrylates, which are the main components of the polymer, polyethylene glycol is preferable in terms of the transportability of ions such as lithium ions. However, since polyethylene glycol exhibits high crystallinity, a method of copolymerizing a propylene glycol structure having poor ion transportability at a certain ratio is used in order to minimize crystallization particularly in a low temperature range. As a result, it is difficult to achieve high ionic conductivity only with the polyether composition with the structures of Formulae (1) to (3).

On the other hand, because the structure of Formula (4) is an anion structure having a relatively large molecular size, the crystallinity can be reduced when the structure of Formula (4) is introduced into the polymer structure. Therefore, in the polyether composition, even if the amount of the propylene glycol structure having poor lithium-ion transportability is reduced, it is possible to minimize crystallization in a low temperature range. As a result, high ion conductivity can be maintained even in a low temperature range.

The content of the structure represented by Formula (4) in the polymer with respect to a total content of 100 parts by mass of the structure represented by Formula (1), the structure represented by Formula (2) and the structure represented by Formula (3) is preferably 1 to 25 parts by mass, more preferably 1 to 10 parts by mass, and still more preferably 1 to 5 parts by mass.

When the content of Formula (4) is within this range, it is possible to expect an improvement in ionic conductivity due to reduced crystallinity while containing a sufficient amount of ions.

The state after these reactions can be confirmed by analysis using known techniques, for example, combustion ion chromatography, pyrolysis GC/MS, FT-IR, and NMR.

### Cation

The cation X⁺ represented by Formula (4) is, for example, at least one selected from the group consisting of a lithium ion, a sodium ion and a potassium ion. The cation may be selected depending on the carrier in the secondary battery. For example, lithium is selected for lithium-ion secondary batteries in which lithium cobalt oxide or the like is used as a positive electrode active material, and sodium is selected for sodium-sulfur secondary batteries.

### Supporting Electrolyte

The polymer electrolyte contains an alkali metal salt. The alkali metal salt can serve as a supporting electrolyte. The alkali metal salt includes an alkali metal salt containing, as an anion, at least one selected from the group consisting of bis(trifluoromethanesulfonyl)imide, bis(fluorosulfonyl)imide, and hexafluorophosphate. Since alkali metal salts having the above specific anions have a high degree of dissociation, polymer electrolytes using these salts can achieve excellent ionic conductivity.

The alkali metal salt is preferably, for example, at least one selected from the group consisting of a lithium salt, a sodium salt, and a potassium salt. For example, the lithium salt is at least one selected from the group consisting of LiN(CF₃SO₂)₂, LiN(SO₂F)₂, and LiPF₆.

The total number of moles of anions, that is, bis(trifluoromethanesulfonyl)imide, bis(fluorosulfonyl)imide, and hexafluorophosphate, in the alkali metal salt per unit mass of the polymer electrolyte is A. In addition, the number of moles of sulfonylimide groups bonded to the polymer is B. In this case, A and B satisfy the relationship of the following Formula (X).

0.50≤A/(A+B) (X)

As described above, satisfying Formula (X) indicates the presence of many free anions, which can minimize ion localization. When A/(A+B) is less than 0.50, the effect of minimizing ion localization cannot be obtained, and dendrites occur.

Here, the sulfonylimide group is represented by the following Formula (S).

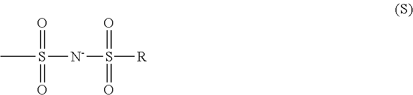

In Formula (S), R is a fluorine atom or a perfluoroalkyl group having 1 to 4 (preferably 1 or 2) carbon atoms.

It is preferable that A and B satisfy 0.65≤A/(A+B)≤0.96.

In addition, the content of the alkali metal salt with respect to 100 parts by mass of the polymer in the polymer electrolyte is preferably from 5 parts by mass to 25 parts by mass. When A/(A+B) and the content of the supporting electrolyte are within the above ranges, the alkali metal salt exhibits favorable compatibility with the polymer and does not precipitate, high ionic conductivity can be obtained without significantly reducing the ion transport number, and the occurrence of dendrites can be further minimized.

As long as the effects of the present disclosure are not impaired, the polymer electrolyte may contain, in addition to the above alkali metal salt, other supporting electrolytes. Examples of other lithium salts include LiBF₄, LiN(SO₂C₂F₅)₂, LiAlCl₄, LiSBF₆, LiSCN, LiCF₃SO₃, LiAsF₆, LiClO₄, lower aliphatic lithium carboxylates, LiCl, LiBR, and LiI. The lithium salts may be used alone or two or more thereof may be used in combination.

Examples of sodium salts and potassium salts include those obtained by substituting lithium in the above lithium salts with sodium or potassium.

The state of the anion in the polymer electrolyte, that is, A and B, can be confirmed by analysis using known techniques, for example, LC/MS, NMR, and GPC.

### Liquid Electrolyte and Electrolytic Solution

The polymer electrolyte may contain a liquid electrolyte or an electrolytic solution as long as the effects of the present disclosure are not impaired, and the safety in a high temperature range is not impaired. Examples thereof include an ionic liquid and a non-aqueous electrolyte solution.

Specific examples of ionic liquids include the combinations of the following cations and anions.

The cation is, for example, at least one selected from the group consisting of quaternary ammonium, imidazolium, pyridinium, pyrrolidinium, and piperidinium.

The anion is, for example, at least one selected from the group consisting of a fluoroalkylsulfonylimide anion, a fluorosulfonylimide anion, a fluoroalkylsulfonate anion, a fluorosulfonate anion, a fluoroalkylcarboxylate anion, a fluoroalkylmethide anion, a fluoroborate anion, a fluorophosphate anion, a dicyanamide anion, a thiocyanate anion, a bis(oxalato)borate anion, a perchlorate anion, and derivatives thereof.

The non-aqueous electrolyte solution is, for example, a liquid in which about 1 mol of a lithium salt is dissolved in a non-aqueous solvent. Examples of non-aqueous solvents include ethylene carbonate, propylene carbonate, dimethyl carbonate, diethyl carbonate, and ethyl methyl carbonate. Examples of lithium salts include LiPF₆, LiBF₄, and LiClO₄.

The ionic conductivity may be improved when the polymer electrolyte contains a liquid electrolyte, but in order to avoid a decrease in mechanical strength at high temperatures, the amount of the liquid electrolyte is, for example, preferably 10 parts by mass or less, 5 parts by mass or less, 1 part by mass or less, or 0.5 parts by mass or less with respect to 100 parts by mass of the polymer contained in the polymer electrolyte.

As necessary, the polymer electrolyte may contain non-conductive fillers such as silica, quartz powder, titanium oxide, zinc oxide and calcium carbonate. When these non-conductive fillers are added to an electrolyte-layer-forming coating material, they function as a film-forming aid when the coating material is applied in the step of forming an electrolyte layer. The content of the non-conductive filler is preferably from 0.1 parts by mass to 10 parts by mass with respect to 100 parts by mass of the polymer forming the electrolyte layer.

In addition, the polymer electrolyte may contain a conductive filler as necessary as long as the effects of the present disclosure are not impaired. As the conductive filler, conductive fine particles such as carbon black, zinc oxide, tin oxide, and titanium dioxide can be used. Particularly, when the polymer electrolyte is used as a positive electrode or negative electrode active material binder, the internal resistance of the secondary battery can be reduced when the polymer electrolyte contains a conductive filler. The content of the conductive filler is preferably from 0.5 parts by mass to 5 parts by mass with respect to 100 parts by mass of the polymer contained in the polymer electrolyte.

The polymer electrolyte is preferably a cured product of an electrolyte solution.

The electrolyte solution may be, for example, a mixture of the following materials.
Polyether mono(meth)acrylate
At least one selected from the group consisting of polyether di(meth)acrylate and polyether tri(meth)acrylate
At least one selected from the group consisting of compounds having an unsaturated reactive functional group, an anionic functional group having a fluorinated sulfonylimide group or a perfluoroalkylsulfonylimide group and a cation

As necessary, the electrolyte solution may contain a known polymerization initiator. Examples of polymerization initiators include a photopolymerization initiator. In addition, known organic solvents such as methyl ethyl ketone may be used.

### Method of Forming Polymer Electrolyte Layer

The method of forming a polymer electrolyte layer is not particularly limited. For example, the above polymer electrolyte materials are mixed using a known method to obtain an electrolyte solution for forming a polymer electrolyte layer. The electrolyte solution is applied by a known application method such as a bar coating application, spin coating application, or roll coating method, and the polymer material contained in the electrolyte solution is then polymerized by a known technique such as UV to form a polymer electrolyte layer. The polymer electrolyte layer can be formed at a desired position such as on the positive electrode or on the negative electrode.

The thickness of the polymer electrolyte layer as the bulk electrolyte is preferably from 5.0 μm to 100.0 μm.

### EXAMPLES

Specific examples and comparative examples according to the present disclosure will be described below. However, the present disclosure is not limited to the following examples and comparative examples.

First, polyether acrylates that formed the structures represented by Formula (1) and Formula (2) were synthesized. Synthesis examples of polyether monoacrylates that could form the structure represented by Formula (1) are shown.

### Synthesis of Polyether Monoacrylate

### Polyether Monoacrylate A-1

15.5 parts by mass of 1-hexanol (commercially available from Tokyo Chemical Industry Co., Ltd.) and 2 parts by mass of potassium hydroxide (commercially available from Kojundo Chemical Laboratory Co., Ltd.) were put into an autoclave, stirred at 120° C. under a reduced pressure, dissolved and dehydrated. Next, the pressure inside the system was reduced to −0.1 MPa at 100° C., and 1,041 parts by mass of a gas mixture of ethylene oxide/propylene oxide at a molar ratio of 8:2 was continuously introduced over 260 minutes while maintaining the pressure inside the container at about 0.5 MPa. While maintaining the temperature at 100° C., the reaction was caused for 180 minutes until the pressure inside the container reached 0.2 MPa or less. Then, the temperature was raised to 130° C. over 30 minutes, and stirring was performed until the change in the pressure inside the container reached 0.01 MPa/30 minutes. 20 parts by mass of pure water was added to the obtained polymer, the mixture was stirred at 90° C. for 30 minutes, 50 g of an alkali adsorbent Kyowaad 600 (commercially available from Kyowa Chemical Industry Co., Ltd.) was then added, and the mixture was additionally stirred for 30 minutes. Next, the alkali adsorbent was removed by filtration and drying was performed under a reduced pressure at 130° C. to obtain a polyether monool with an Mn of 6,000.

Next, 100 parts by mass of the obtained polyether monool, 1.26 parts by mass of acrylic acid (commercially available from Nippon Shokubai Co., Ltd.), 2.02 parts by mass of paratoluenesulfonic acid (commercially available from Tokyo Chemical Industry Co., Ltd.), 0.08 parts by mass of hydroquinone (commercially available from Tokyo Chemical Industry Co., Ltd.), and 250 m1 of toluene were put into a Dean-Stark reaction device including a stirring device. The mixture was heated and stirred at 115° C., and reacted for 5 hours while removing water produced by the reaction from the system.

Then, the reaction solution temperature was lowered to room temperature, washed twice with 120 g of a 5% sodium hydroxide aqueous solution, and additionally washed three times with 120 g of pure water. The organic phase was separated from the reaction solution after washing, and the solvent was distilled off under a reduced pressure to obtain a polyether monoacrylate A-1.

### Polyether Monoacrylate A-2

18.6 parts by mass of 1-hexanol (commercially available from Tokyo Chemical Industry Co., Ltd.), and 2 parts by mass of potassium hydroxide (commercially available from Kojundo Chemical Laboratory Co., Ltd.) were put into an autoclave, stirred at 120° C. under a reduced pressure, dissolved and dehydrated. Next, the pressure inside the system was reduced to −0.1 MPa at 100° C., and 976 parts by mass of a gas mixture of ethylene oxide/propylene oxide at a molar ratio of 95:5 was continuously introduced over 240 minutes while maintaining the pressure inside the container at about 0.5 MPa. While maintaining the temperature at 100° C., the reaction was caused for 180 minutes until the pressure inside the container reached 0.2 MPa or less. Then, the temperature was raised to 130° C. over 30 minutes, and stirring was performed until the change in the pressure inside the container reached 0.01 MPa/30 minutes. 20 parts by mass of pure water was added to the obtained polymer, the mixture was stirred at 90° C. for 30 minutes, 50 g of an alkali adsorbent Kyowaad 600 (commercially available from Kyowa Chemical Industry Co., Ltd.) was then added, and the mixture was additionally stirred for 30 minutes. Next, the alkali adsorbent was removed by filtration and drying was performed under a reduced pressure at 130° C. to obtain a polyether monool with an Mn of 5,000.

Next, 100 parts by mass of the obtained polyether monool, 1.51 parts by mass of acrylic acid (commercially available from Nippon Shokubai Co., Ltd.), 2.42 parts by mass of paratoluenesulfonic acid (commercially available from Tokyo Chemical Industry Co., Ltd.), 0.08 parts by mass of hydroquinone (commercially available from Tokyo Chemical Industry Co., Ltd.), and 250 m1 of toluene were put into a Dean-Stark reaction device including a stirring device. The mixture was heated and stirred at 115° C., and reacted for 5 hours while removing water produced by the reaction from the system.

Then, the reaction solution temperature was lowered to room temperature, washed twice with 120 g of a 5% sodium hydroxide aqueous solution, and additionally washed three times with 120 g of pure water. The organic phase was separated from the reaction solution after washing, and the solvent was distilled off under a reduced pressure to obtain a polyether monoacrylate A-2.

### Polyether Monoacrylate A-3

A polyether monoacrylate A-3 was obtained in the same manner as the polyether monoacrylate A-2 except that the molar ratio of the gas mixture of ethylene oxide/propylene oxide was changed to 8:2.

### Polyether Monoacrylate A-4

33.7 parts by mass of 1-butanol (commercially available from Tokyo Chemical Industry Co., Ltd.), and 2 parts by mass of potassium hydroxide (commercially available from Kojundo Chemical Laboratory Co., Ltd.) were put into an autoclave, stirred at 120° C. under a reduced pressure, dissolved and dehydrated. Next, the pressure inside the system was reduced to −0.1 MPa at 100° C., and 984 parts by mass of a gas mixture of ethylene oxide/propylene oxide at a molar ratio of 8:2 was continuously introduced over 240 minutes while maintaining the pressure inside the container at about 0.5 MPa. While maintaining the temperature at 100° C., the reaction was caused for 150 minutes until the pressure inside the container reached 0.2 MPa or less. Then, the temperature was raised to 130° C. over 30 minutes, and stirring was performed until the change in the pressure inside the container reached 0.01 MPa/30 minutes. 20 parts by mass of pure water was added to the obtained polymer, the mixture was stirred at 90° C. for 30 minutes, 50 g of an alkali adsorbent Kyowaad 600 (commercially available from Kyowa Chemical Industry Co., Ltd.) was then added, and the mixture was additionally stirred for 30 minutes. Next, the alkali adsorbent was removed by filtration and drying was performed under a reduced pressure at 130° C. to obtain a polyether monool with an Mn of 2,000.

Next, 100 parts by mass of the obtained polyether monool, 3.78 parts by mass of acrylic acid (commercially available from Nippon Shokubai Co., Ltd.), 6.05 parts by mass of paratoluenesulfonic acid (commercially available from Tokyo Chemical Industry Co., Ltd.), 0.11 parts by mass of hydroquinone (commercially available from Tokyo Chemical Industry Co., Ltd.), and 250 m1 of toluene were put into a Dean-Stark reaction device including a stirring device. The mixture was heated and stirred at 115° C., and reacted for 6 hours while removing water produced by the reaction from the system.

Then, the reaction solution temperature was lowered to room temperature, washed twice with 120 g of a 5% sodium hydroxide aqueous solution, and additionally washed three times with 120 g of pure water. The organic phase was separated from the reaction solution after washing, and the solvent was distilled off under a reduced pressure to obtain a polyether monoacrylate A-4.

### Polyether Monoacrylate A-5

67.4 parts by mass of 1-butanol (commercially available from Tokyo Chemical Industry Co., Ltd.), and 2 parts by mass of potassium hydroxide (commercially available from Kojundo Chemical Laboratory Co., Ltd.) were put into an autoclave, stirred at 120° C. under a reduced pressure, dissolved and dehydrated. Next, the pressure inside the system was reduced to −0.1 MPa at 100° C., and 946 parts by mass of a gas mixture of ethylene oxide/propylene oxide at a molar ratio of 8:2 was continuously introduced over 240 minutes while maintaining the pressure inside the container at about 0.5 MPa. While maintaining the temperature at 100° C., the reaction was caused for 130 minutes until the pressure inside the container reached 0.2 MPa or less. Then, the temperature was raised to 130° C. over 30 minutes, and stirring was performed until the change in the pressure inside the container reached 0.01 MPa/30 minutes. 20 parts by mass of pure water was added to the obtained polymer, the mixture was stirred at 90° C. for 30 minutes, 50 g of an alkali adsorbent Kyowaad 600 (commercially available from Kyowa Chemical Industry Co., Ltd.) was then added, and the mixture was additionally stirred for 30 minutes. Next, the alkali adsorbent was removed by filtration and drying was performed under a reduced pressure at 130° C. to obtain a polyether monool with an Mn of 1,000.

Next, 100 parts by mass of the obtained polyether monool, 7.56 parts by mass of acrylic acid (commercially available from Nippon Shokubai Co., Ltd.), 12.1 parts by mass of paratoluenesulfonic acid (commercially available from Tokyo Chemical Industry Co., Ltd.), 0.11 parts by mass of hydroquinone (commercially available from Tokyo Chemical Industry Co., Ltd.), and 250 m1 of toluene were put into a Dean-Stark reaction device including a stirring device. The mixture was heated and stirred at 115° C., and reacted for 6 hours while removing water produced by the reaction from the system.

Then, the reaction solution temperature was lowered to room temperature, washed twice with 120 g of a 5% sodium hydroxide aqueous solution, and additionally washed three times with 120 g of pure water. The organic phase was separated from the reaction solution after washing, and the solvent was distilled off under a reduced pressure to obtain a polyether monoacrylate A-5.

### Polyether Monoacrylate A-6

169 parts by mass of 1-butanol (commercially available from Tokyo Chemical Industry Co., Ltd.), and 5 parts by mass of potassium hydroxide (commercially available from Kojundo Chemical Laboratory Co., Ltd.) were put into an autoclave, stirred at 120° C. under a reduced pressure, dissolved and dehydrated. Next, the pressure inside the system was reduced to −0.1 MPa at 100° C., and 937 parts by mass of a gas mixture of ethylene oxide/propylene oxide at a molar ratio of 8:2 was continuously introduced over 240 minutes while maintaining the pressure inside the container at about 0.5 MPa. While maintaining the temperature at 100° C., the reaction was caused for 120 minutes until the pressure inside the container reached 0.2 MPa or less. Then, the temperature was raised to 130° C. over 30 minutes, and stirring was performed until the change in the pressure inside the container reached 0.01 MPa/30 minutes. 20 parts by mass of pure water was added to the obtained polymer, the mixture was stirred at 90° C. for 30 minutes, 50 g of an alkali adsorbent Kyowaad 600 (commercially available from Kyowa Chemical Industry Co., Ltd.) was then added, and the mixture was additionally stirred for 30 minutes. Next, the alkali adsorbent was removed by filtration and drying was performed under a reduced pressure at 130° C. to obtain a polyether monool with an Mn of 400.

Next, 100 parts by mass of the obtained polyether monool, 18.9 parts by mass of acrylic acid (commercially available from Nippon Shokubai Co., Ltd.), 24.2 parts by mass of paratoluenesulfonic acid (commercially available from Tokyo Chemical Industry Co., Ltd.), 0.11 parts by mass of hydroquinone (commercially available from Tokyo Chemical Industry Co., Ltd.), and 250 m1 of toluene were put into a Dean-Stark reaction device including a stirring device. The mixture was heated and stirred at 115° C., and reacted for 6 hours while removing water produced by the reaction from the system.

Then, the reaction solution temperature was lowered to room temperature, washed twice with 120 g of a 5% sodium hydroxide aqueous solution, and additionally washed three times with 120 g of pure water. The organic phase was separated from the reaction solution after washing, and the solvent was distilled off under a reduced pressure to obtain a polyether monoacrylate A-6.

### Polyether Monoacrylate A-7

A polyether monoacrylate A-7 was obtained in the same manner as the polyether monoacrylate A-5 except that the molar ratio of the gas mixture of ethylene oxide/propylene oxide was changed to 5:5.

### Polyether Monomethacrylate A-8

112 parts by mass of 1-butanol (commercially available from Tokyo Chemical Industry Co., Ltd.), and 5 parts by mass of potassium hydroxide (commercially available from Kojundo Chemical Laboratory Co., Ltd.) were put into an autoclave, stirred at 120° C. under a reduced pressure, dissolved and dehydrated. Next, the pressure inside the system was reduced to −0.1 MPa at 100° C., and 937 parts by mass of a gas mixture of ethylene oxide/propylene oxide at a molar ratio of 5:5 was continuously introduced over 240 minutes while maintaining the pressure inside the container at about 0.5 MPa. While maintaining the temperature at 100° C., the reaction was caused for 120 minutes until the pressure inside the container reached 0.2 MPa or less. Then, the temperature was raised to 130° C. over 30 minutes, and stirring was performed until the change in the pressure inside the container reached 0.01 MPa/30 minutes. 20 parts by mass of pure water was added to the obtained polymer, the mixture was stirred at 90° C. for 30 minutes, 50 g of an alkali adsorbent Kyowaad 600 (commercially available from Kyowa Chemical Industry Co., Ltd.) was then added, and the mixture was additionally stirred for 30 minutes. Next, the alkali adsorbent was removed by filtration and drying was performed under a reduced pressure at 130° C. to obtain a polyether monool with an Mn of 600.

Next, 100 parts by mass of the obtained polyether monool, 15.0 parts by mass of methacrylic acid (commercially available from Mitsubishi Gas Chemical Company, Inc.), 20.2 parts by mass of paratoluenesulfonic acid (commercially available from Tokyo Chemical Industry Co., Ltd.), 0.11 parts by mass of hydroquinone (commercially available from Tokyo Chemical Industry Co., Ltd.), and 250 m1 of toluene were put into a Dean-Stark reaction device including a stirring device. The mixture was heated and stirred at 115° C., and reacted for 6 hours while removing water produced by the reaction from the system.

Then, the reaction solution temperature was lowered to room temperature, washed twice with 120 g of a 5% sodium hydroxide aqueous solution, and additionally washed three times with 120 g of pure water. The organic phase was separated from the reaction solution after washing, and the solvent was distilled off under a reduced pressure to obtain a polyether monomethacrylate A-8.

### Polyether Monomethacrylate A-9

A polyether monool with an Mn of 400 was obtained in the same manner as the polyether monoacrylate A-6 except that the molar ratio of the gas mixture of ethylene oxide/propylene oxide was changed to 5:5.

Next, 100 parts by mass of the obtained polyether monool, 22.6 parts by mass of methacrylic acid (commercially available from Mitsubishi Gas Chemical Company, Inc.), 24.2 parts by mass of paratoluenesulfonic acid (commercially available from Tokyo Chemical Industry Co., Ltd.), 0.11 parts by mass of hydroquinone (commercially available from Tokyo Chemical Industry Co., Ltd.), and 250 m1 of toluene were put into a Dean-Stark reaction device including a stirring device. The mixture was heated and stirred at 115° C., and reacted for 6 hours while removing water produced by the reaction from the system.

Then, the reaction solution temperature was lowered to room temperature, washed twice with 120 g of a 5% sodium hydroxide aqueous solution, and additionally washed three times with 120 g of pure water. The organic phase was separated from the reaction solution after washing, and the solvent was distilled off under a reduced pressure to obtain a polyether monomethacrylate A-9.

The obtained polyether mono(meth)acrylates are shown in Table 1.

Next, synthesis examples of polyether diacrylates that could form the structure represented by Formula (2) are shown.

### Synthesis of Polyether Diacrylate

### Polyether Diacrylate B-1

13.7 parts by mass of 1,4-butanediol (commercially available from Tokyo Chemical Industry Co., Ltd.) and 2 parts by mass of potassium hydroxide (commercially available from Kojundo Chemical Laboratory Co., Ltd.) were put into an autoclave, stirred at 120° C. under a reduced pressure, dissolved and dehydrated. Next, the pressure inside the system was reduced to −0.1 MPa at 100° C., and 1,041 parts by mass of a gas mixture of ethylene oxide/propylene oxide at a molar ratio of 8:2 was continuously introduced over 280 minutes while maintaining the pressure inside the container at about 0.5 MPa. While maintaining the temperature at 100° C., the reaction was caused for 170 minutes until the pressure inside the container reached 0.2 MPa or less. Then, the temperature was raised to 130° C. over 30 minutes, and stirring was performed until the change in the pressure inside the container reached 0.01 MPa/30 minutes. 20 parts by mass of pure water was added to the obtained polymer, the mixture was stirred at 90° C. for 30 minutes, 50 g of an alkali adsorbent Kyowaad 600 (commercially available from Kyowa Chemical Industry Co., Ltd.) was then added, and the mixture was additionally stirred for 30 minutes. Next, the alkali adsorbent was removed by filtration and drying was performed under a reduced pressure at 130° C. to obtain a polyether diol with an Mn of 6,000.

Next, 100 parts by mass of the obtained polyether diol, 2.52 parts by mass of acrylic acid (commercially available from Nippon Shokubai Co., Ltd.), 2.02 parts by mass of paratoluenesulfonic acid (commercially available from Tokyo Chemical Industry Co., Ltd.), 0.08 parts by mass of hydroquinone (commercially available from Tokyo Chemical Industry Co., Ltd.), and 250 m1 of toluene were put into a Dean-Stark reaction device including a stirring device. The mixture was heated and stirred at 115° C., and reacted for 5 hours while removing water produced by the reaction from the system.

Then, the reaction solution temperature was lowered to room temperature, washed twice with 120 g of a 5% sodium hydroxide aqueous solution, and additionally washed three times with 120 g of pure water. The organic phase was separated from the reaction solution after washing, and the solvent was distilled off under a reduced pressure to obtain a polyether diacrylate B-1.

### Polyether Diacrylate B-2

A polyether diol with an Mn of 5,000 was obtained in the same manner as the polyether diacrylate B-1 except that the amount of 1,4-butanediol (commercially available from Tokyo Chemical Industry Co., Ltd.) was changed to 16.4 parts by mass.

Next, 100 parts by mass of the obtained polyether diol, 3.02 parts by mass of acrylic acid (commercially available from Nippon Shokubai Co., Ltd.), 2.42 parts by mass of paratoluenesulfonic acid (commercially available from Tokyo Chemical Industry Co., Ltd.), 0.08 parts by mass of hydroquinone (commercially available from Tokyo Chemical Industry Co., Ltd.), and 250 m1 of toluene were put into a Dean-Stark reaction device including a stirring device. The mixture was heated and stirred at 115° C., and reacted for 5 hours while removing water produced by the reaction from the system.

Then, the reaction solution temperature was lowered to room temperature, washed twice with 120 g of a 5% sodium hydroxide aqueous solution, and additionally washed three times with 120 g of pure water. The organic phase was separated from the reaction solution after washing, and the solvent was distilled off under a reduced pressure to obtain a polyether diacrylate B-2.

### Polyether Diacrylate B-3

41.0 parts by mass of 1,4-butanediol (commercially available from Tokyo Chemical Industry Co., Ltd.) and 2 parts by mass of potassium hydroxide (commercially available from Kojundo Chemical Laboratory Co., Ltd.) were put into an autoclave and stirred at 120° C. under a reduced pressure, dissolved and dehydrated. Next, the pressure inside the system was reduced to −0.1 MPa at 100° C., and 955 parts by mass of a gas mixture of ethylene oxide/propylene oxide at a molar ratio of 9:1 was continuously introduced over 220 minutes while maintaining the pressure inside the container at about 0.5 MPa. While maintaining the temperature at 100° C., the reaction was caused for 150 minutes until the pressure inside the container reached 0.2 MPa or less. Then, the temperature was raised to 130° C. over 30 minutes, and stirring was performed until the change in the pressure inside the container reached 0.01 MPa/30 minutes. 20 parts by mass of pure water was added to the obtained polymer, the mixture was stirred at 90° C. for 30 minutes, 50 g of an alkali adsorbent Kyowaad 600 (commercially available from Kyowa Chemical Industry Co., Ltd.) was then added, and the mixture was additionally stirred for 30 minutes. Next, the alkali adsorbent was removed by filtration and drying was performed under a reduced pressure at 130° C. to obtain a polyether diol with an Mn of 2,000.

Next, 100 parts by mass of the obtained polyether diol, 7.56 parts by mass of acrylic acid (commercially available from Nippon Shokubai Co., Ltd.), 6.05 parts by mass of paratoluenesulfonic acid (commercially available from Tokyo Chemical Industry Co., Ltd.), 0.11 parts by mass of hydroquinone (commercially available from Tokyo Chemical Industry Co., Ltd.), and 250 m1 of toluene were put into a Dean-Stark reaction device including a stirring device. The mixture was heated and stirred at 115° C., and reacted for 5 hours while removing water produced by the reaction from the system.

Then, the reaction solution temperature was lowered to room temperature, washed twice with 120 g of a 5% sodium hydroxide aqueous solution, and additionally washed three times with 120 g of pure water. The organic phase was separated from the reaction solution after washing, and the solvent was distilled off under a reduced pressure to obtain a polyether diacrylate B-3.

### Polyether Diacrylate B-4

205 parts by mass of 1,4-butanediol (commercially available from Tokyo Chemical Industry Co., Ltd.), and 2 parts by mass of potassium hydroxide (commercially available from Kojundo Chemical Laboratory Co., Ltd.) were put into an autoclave, stirred at 120° C. under a reduced pressure, dissolved and dehydrated. Next, the pressure inside the system was reduced to −0.1 MPa at 100° C., and 899 parts by mass of a gas mixture of ethylene oxide/propylene oxide at a molar ratio of 9:1 was continuously introduced over 210 minutes while maintaining the pressure inside the container at about 0.5 MPa. While maintaining the temperature at 100° C., the reaction was caused for 110 minutes until the pressure inside the container reached 0.2 MPa or less. Then, the temperature was raised to 130° C. over 30 minutes, and stirring was performed until the change in the pressure inside the container reached 0.01 MPa/30 minutes. 20 parts by mass of pure water was added to the obtained polymer, the mixture was stirred at 90° C. for 30 minutes, 50 g of an alkali adsorbent Kyowaad 600 (commercially available from Kyowa Chemical Industry Co., Ltd.) was then added, and the mixture was additionally stirred for 30 minutes. Next, the alkali adsorbent was removed by filtration and drying was performed under a reduced pressure at 130° C. to obtain a polyether diol with an Mn of 400.

Next, 100 parts by mass of the obtained polyether diol, 37.8 parts by mass of acrylic acid (commercially available from Nippon Shokubai Co., Ltd.), 24.2 parts by mass of paratoluenesulfonic acid (commercially available from Tokyo Chemical Industry Co., Ltd.), 0.11 parts by mass of hydroquinone (commercially available from Tokyo Chemical Industry Co., Ltd.), and 250 m1 of toluene were put into a Dean-Stark reaction device including a stirring device. The mixture was heated and stirred at 115° C., and reacted for 6 hours while removing water produced by the reaction from the system.

Then, the reaction solution temperature was lowered to room temperature, washed twice with 120 g of a 5% sodium hydroxide aqueous solution, and additionally washed three times with 120 g of pure water. The organic phase was separated from the reaction solution after washing, and the solvent was distilled off under a reduced pressure to obtain a polyether diacrylate B-4.

### Polyether Diacrylate B-5

A polyether diacrylate B-5 was obtained in the same manner as the polyether diacrylate B-2 except that the molar ratio of the gas mixture of ethylene oxide/propylene oxide was changed to 9:1.

### Polyether Dimethacrylate B-6

A polyether diol with an Mn of 1,000 was obtained in the same manner as the polyether diacrylate B-3 except that 82.0 parts by mass of 1,4-butanediol (commercially available from Tokyo Chemical Industry Co., Ltd.) was used, and the molar ratio of the gas mixture of ethylene oxide/propylene oxide was changed to 5:5.

Next, 100 parts by mass of the obtained polyether diol, 18.1 parts by mass of methacrylic acid (commercially available from Mitsubishi Gas Chemical Company, Inc.), 12.1 parts by mass of paratoluenesulfonic acid (commercially available from Tokyo Chemical Industry Co., Ltd.), 0.11 parts by mass of hydroquinone (commercially available from Tokyo Chemical Industry Co., Ltd.), and 250 m1 of toluene were put into a Dean-Stark reaction device including a stirring device. The mixture was heated and stirred at 115° C., and reacted for 6 hours while removing water produced by the reaction from the system. Then, the reaction solution temperature was lowered to room temperature, washed twice with 120 g of a 5% sodium hydroxide aqueous solution, and additionally washed three times with 120 g of pure water. The organic phase was separated from the reaction solution after washing, and the solvent was distilled off under a reduced pressure to obtain a polyether diacrylate B-6.

The obtained polyether di(meth)acrylates are shown in Table 2.

TABLE 1

| | | Polyether | | Polyether | | Number of | | Average number | |
|---|---|---|---|---|---|---|---|---|---|
| | Molecular | composition ratio | | Starting | Molecular | carbon atoms | | of moles added | |
| | structure | EO | PO | substance | weight | R2 | R3 | m1 | n1 |
| A-1 | Monoacrylate | 80 | 20 | 1-Hexanol | 6000 | 2 or 3 | 6 | 108 | 20 |
| A-2 | | 95 | 5 | | 5000 | 2 or 3 | 6 | 106 | 4 |
| A-3 | | 80 | 20 | | 5000 | 2 or 3 | 6 | 89 | 17 |
| A-4 | | 80 | 20 | 1-Butanol | 2000 | 2 or 3 | 4 | 35 | 7 |
| A-5 | | 80 | 20 | | 1000 | 2 or 3 | 4 | 17 | 3 |
| A-6 | | 80 | 20 | | 400 | 2 or 3 | 4 | 6 | 1 |
| A-7 | | 50 | 50 | | 1000 | 2 or 3 | 4 | 11 | 8 |
| A-8 | Mono(meth)acrylate | 50 | 50 | | 600 | 2 or 3 | 4 | 6 | 5 |
| A-9 | | 50 | 50 | | 400 | 2 or 3 | 4 | 4 | 3 |

The polyether composition ratio indicates the molar ratio. EO indicates ethylene oxide, and PO indicates propylene oxide.

TABLE 2

| | | Polyether | | Polyether | | Number of | | Average number | |
|---|---|---|---|---|---|---|---|---|---|
| | Molecular | composition ratio | | Starting | Molecular | carbon atoms | | of moles added | |
| | structure | EO | PO | substance | weight | R5 | R6 | m2 | n2 |
| B-1 | Diacrylate | 80 | 20 | 1,4- | 6000 | 2 or 3 | 2 or 3 | 109 | 21 |
| B-2 | | 80 | 20 | Butanediol | 5000 | 2 or 3 | 2 or 3 | 91 | 17 |
| B-3 | | 90 | 10 | | 2000 | 2 or 3 | 2 or 3 | 41 | 3 |
| B-4 | | 90 | 10 | | 400 | 2 or 3 | 2 or 3 | 8 | 1 |
| B-5 | | 90 | 10 | | 5000 | 2 or 3 | 2 or 3 | 102 | 9 |
| B-6 | Dimethacrylate | 50 | 50 | | 1000 | 2 or 3 | 2 or 3 | 11 | 9 |

The polyether composition ratio indicates the molar ratio. EO indicates ethylene oxide, and PO indicates propylene oxide.

### Synthesis of Reactive Ionic Compounds

### Synthesis of Ionic Compound C-1

15.0 g (0.06 mol) of 3-sulfopropyl methacrylate potassium salt (commercially available from Tokyo Chemical Industry Co., Ltd.) was suspended in 100 mL of THF, and 0.5 mL of N,N-dimethylformamide, 20 mL (0.28 mol) of thionyl chloride was then added, and the mixture was stirred for 3 hours. The mixture was concentrated under a reduced pressure, the residue was dissolved in dichloromethane, washing with 50 mL of pure water and 50 mL of a saline was then performed, and the mixture was then concentrated again under a reduced pressure to obtain a light yellow liquid.

The obtained light yellow liquid was added to a solution obtained by dissolving 9.20 g (0.06 mol) of trifluoromethanesulfonamide (commercially available from Tokyo Chemical Industry Co., Ltd.) and 27.3 mL (0.20 mol) of triethylamine (commercially available from Kishida Chemical Co., Ltd.) in 50 mL of tetrahydrofuran, the mixture was stirred for 2 hours, and the reaction solution was then concentrated under a reduced pressure. The obtained residue was dissolved in dichloromethane, washing with 150 mL of pure water was then performed, and the organic layer was dried under a reduced pressure to obtain a yellow liquid. The obtained yellow liquid was dissolved in 300 mL of tetrahydrofuran, 1.43 g (0.18 mol) of lithium hydride (commercially available from FUJIFILM Wako Pure Chemical Corporation) was added, and the mixture was stirred overnight. Unreacted lithium hydride was filtered through Celite and the filtrate was then dried under a reduced pressure to obtain an ionic compound C-1.

### Synthesis of Ionic Compound C-2

An ionic compound C-2 was obtained in the same manner as the ionic compound C-1 except that the starting raw material was changed to 15.9 g (0.06 mol) of 3-sulfopropyl acrylate potassium salt (commercially available from Tokyo Chemical Industry Co., Ltd.).

### Synthesis of Ionic compound C-3

7.78 g (0.07 mol) of hydroxymethanesulfonate (commercially available from Atomax Chemicals Product) was dissolved in 50 mL of THF, 5.17 g (0.06 mol) of methacrylic acid (commercially available from Kishida Chemical Co., Ltd.) and molecular sieves were added, and the mixture was stirred at 80° C. for 3 hours. The filtrate obtained through Celite was dried under a reduced pressure and then dissolved again in 50 mL of THF, 2.41 g (0.06 mol) of potassium hydride (commercially available from Merck) was added, and the mixture was stirred at room temperature for 2 hours. The white solid obtained after drying under a reduced pressure was used as a starting raw material, and an ionic compound C-3 was obtained in the same manner as the ionic compound C-1.

### Synthesis of Ionic Compound C-4

12.9 g of 1-heptanesulfonyl chloride, 7-hydroxy (commercially available from Hong Kong Chemhere Product), and 6.07 g (0.06 mol) of triethylamine (commercially available from Kishida Chemical Co., Ltd.) were added to 80 mL of dichloromethane, and the mixture was stirred at room temperature. After washing with 100 mL of pure water, the organic phase was dried under a reduced pressure to obtain an oily liquid. 5.64 g (0.06 mol) of sodium acrylate (commercially available from Merck) was dissolved in 50 mL of ethanol, the oily liquid obtained above and 0.022 g (0.20 mmol) of hydroquinone (commercially available from Kanto Chemical Co., Inc.) were added, and the mixture was stirred at 70° C. for 5 hours. The light yellow solid obtained after drying under a reduced pressure was used as a starting raw material, and an ionic compound C-4 was obtained in the same manner as the ionic compound C-2.

### Synthesis of Ionic Compound C-5

An ionic compound C-5 was obtained in the same manner as the ionic compound C-2 except that, as the reaction product, trifluoromethanesulfonamide (commercially available from Tokyo Chemical Industry Co., Ltd.) was changed to 5.94 g (0.06 mol) of sulfamoylfluoride (commercially available from Atomax Chemicals Product).

### Synthesis of Ionic Compound C-6

An ionic compound C-6 was obtained in the same manner as the ionic compound C-1 except that, as the reaction product, trifluoromethanesulfonamide (commercially available from Tokyo Chemical Industry Co., Ltd.) was changed to 18.0 g (0.06 mol) of nonafluorobutane-1-sulfonamide (commercially available from Enamine Ltd.).

### Synthesis of Ionic Compound C-7

An ionic compound C-7 was obtained in the same manner as the ionic compound C-5 except that, as the reaction product, lithium hydride was changed to 4.32 g (0.18 mol) of sodium hydride (commercially available from Tokyo Chemical Industry Co., Ltd.).

### Synthesis of Ionic Compound C-8

An ionic compound C-8 was obtained in the same manner as the ionic compound C-6 except that, as the reaction product, lithium hydride was changed to 7.22 g (0.18 mol) of potassium hydride (commercially available from Merck).

The chemical structures of the obtained reactive ionic compounds are shown in Formulae C-1 to C-8.

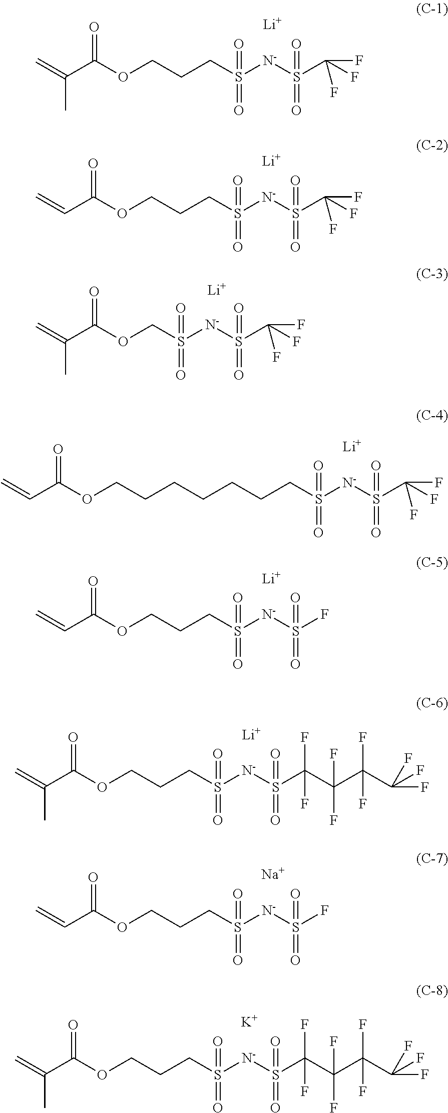

### Production of Electrolyte Solution of Polymer Electrolyte

### Example 1

As polymer electrolyte materials, the following materials were mixed and stirred.
Polyether monoacrylate NK ester M-230G (commercially available from Shin-Nakamura Chemical Co., Ltd.): 50.0 parts by mass
Polyether diacrylate B-1: 50.0 parts by mass
Ionic compound C-3: 5.0 parts by mass
Supporting electrolyte Li TFSI (lithium bis(trifluoromethanesulfonyl)imide): 20 parts
Initiator Omnirad184 (commercially available from IGM RESINS B.V.): 2.0 parts by mass

Next, methyl ethyl ketone (hereinafter referred to as “MEK”) was added so that the total solid content was 60 mass %, and the mixture was then mixed by motor stirring to prepare an electrolyte solution.

### Measurement of Volume Swelling Ratio by MEK Immersion Method

Test pieces for determining the volume swelling ratio by the MEK immersion method were produced using electrolyte solutions of examples as follows. A predetermined amount of a surface-layer-forming dispersion solution of each example was added to an aluminum mold whose surface was coated with a fluorine resin so that the film thickness was 200 μm. Next, the sample was placed on a sunflower-type stand and dried until the viscosity increased to the extent that the film surface did not flow, and then placed on a horizontal table and dried at 60° C. for 2 hours.

Next, UV light was emitted to the film surface using a high-pressure mercury UV radiation device (product name: Handy 1000, commercially available from Marionetwork) in an atmospheric atmosphere so that the cumulative light dose was 5,000 mJ/cm², and the polymer electrolyte was cross-linked and cured.

After curing, the sample was left in an environment of 23° C. and 40% RH for 24 hours, and the electrolyte film was removed from the aluminum mold to produce a sheet with a film thickness of 200 μm. The obtained polymer electrolyte sheet was cut into 50 mm×50 mm, and left in an environment of 23° C. and 40% RH for 24 hours to prepare a test piece.

First, the initial weight in air (W1) and the initial weight in water (W2) were measured in an environment of 23° C. and 40% RH. Next, the test piece after initial weight measurement was immersed in MEK at 23° C. for 48 hours. Immediately after removing the test piece from MEK, MEK on the surface was wiped off with a nonwoven fabric, the test piece was placed in a pre-weighed weighing bottle, and the weight after immersion in air (W3) and the weight after immersion in water (W4) were measured. The volume swelling ratio after immersion in MEK was calculated using the following formula.

Volume swelling ratio (%)=((W3-W4)−(W1-W2))/(W1-W2)×100
W1: initial weight in air
W2: initial weight in water
W3: weight after immersion in air
W4: weight after immersion in water

### Measurement of Ionic Conductivity at Normal Temperature (25° C.)

The electrolyte solution obtained in Example 1 was applied to an aluminum plate with a thickness of 100 m using a bar coater and dried at 60° C. for 30 minutes. Next, UV light was emitted to the film surface using a high-pressure mercury UV radiation device (product name: Handy 1000, commercially available from Marionetwork) so that the cumulative light dose was 5,000 mJ/cm² and the polymer electrolyte film according to Example 1 was cross-linked and cured. The film thickness after curing was 60 μm.

The obtained polymer electrolyte film was punched out together with the aluminum substrate into pieces with a diameter of 50 mm and vacuum-dried at 80° C. for 48 hours. Then, the polymer electrolyte film was put into a glove box (a temperature of 25° C. and a dew point of −70° C.) purged with argon, the AC impedance between the electrodes was measured using an impedance analyzer E4990A (commercially available from KEYSIGHT) at an applied voltage of 10 mV in a frequency range of 100 MHz to 1 Hz, the bulk resistance value R^{B} (Ω) was obtained from the intercept of the real impedance of the obtained cole-cole plot, and the ionic conductivity was determined by the following formula.

σ=L/R^{B}×S
(σ: ionic conductivity (S·cm⁻¹), L: sample thickness (cm), S: sample area (cm²))

### Measurement of Ionic Conductivity at Low Temperature (5° C.)

In the same manner as in the ionic conductivity measurement at normal temperature, a polymer electrolyte film formed on an aluminum plate was obtained. Then, the polymer electrolyte film was put into a glove box (a temperature of 25° C. and a dew point of −70° C.) purged with argon, and incorporated into an all-solid-state battery evaluation cell (commercially available from Hohsen Corporation).

The evaluation cell into which the polymer electrolyte film was incorporated was placed in a low-temperature environmental test machine and left at 5° C. for 1 hour. Then, the ionic conductivity at low temperatures was determined in the same manner as in the above measurement.

### Production of Secondary Battery

1. Configuration in which the Polymer Electrolyte of the Present Disclosure was Used as a Bulk Electrolyte

### Production of Negative Electrode

A 20 mm×20 mm lithium foil with a thickness of 60 m (commercially available from Honjo Metal Co., Ltd.) was laminated on a 20 mm×30 mm copper foil with a thickness of 20 μm, leaving a 10 mm non-laminated end on one side, and press-bonding was performed to produce a negative electrode. The total thickness of the produced negative electrode was 70 μm. In the negative electrode, a nickel-plated copper tab with a width of 5 mm was bonded to the one-side non-laminated end.

### Production of Positive Electrode

100 parts by mass of lithium cobalt oxide (commercially available from FUJIFILM Wako Pure Chemical Corporation), 7 parts by mass of Kureha KF Polymer L #1120 (commercially available from Kureha Corporation) as an active material binder, and 5 parts by mass of Denka Black Li-100 (commercially available from Denka Co., Ltd.) as a conductivity aid were mixed, 40 parts by mass of N-methylpyrrolidone was added, and the mixture was mixed and stirred. Next, the obtained slurry was applied onto a 15 mm×25 mm rolled aluminum foil with a thickness of 20 μm, leaving a 10 mm non-coated end on one side, dried at 100° C. for 30 minutes, and pressing was performed to obtain a positive electrode. The thickness of the positive electrode was 80 μm.

In the positive electrode, an aluminum tab with a width of 5 mm was bonded to the one-side non-coated end.

### Formation of Polymer Electrolyte Layer

The electrolyte solution was applied to the entire surface of the obtained positive electrode coated with the active material using a bar coater, air-dried at 23° C. for 10 minutes, and then dried at 60° C. for 30 minutes. Next, UV light was emitted to the film surface using a high-pressure mercury UV radiation device (product name: Handy 1000, commercially available from Marionetwork) so that the cumulative light dose was 5,000 mJ/cm², and curing was performed. The film thickness after curing was 60 μm.

### Production of Secondary Battery Using Polymer Electrolyte as Bulk Electrolyte

The positive electrode coated with the polymer electrolyte was vacuum-dried at 80° C. for 48 hours. Then, the polymer electrolyte film was put into a glove box (a temperature of 25° C. and a dew point of −70° C.) purged with argon, and a polyimide sheet punched into a window frame shape was attached to cover the outer peripheral part of the positive electrode surface to form a short-circuiting prevention layer. Next, lamination was performed so that the polymer electrolyte layer of the positive electrode coated with the polymer electrolyte corresponded to the lithium layer of the negative electrode. The laminate was inserted into the aluminum laminate film and vacuum-packed to obtain a secondary battery according to Example 1.

### Evaluation of Battery Characteristics

### Rate Characteristics

The theoretical capacity was determined from the total mass of lithium cobalt oxide contained in the positive electrode. The prototype secondary batteries were subjected to a charging and discharging test at 25° C. using a charging and discharging device BCS-805 (commercially available from BioLogic Co., Ltd.).

The theoretical capacity was determined from the total mass of lithium cobalt oxide contained in the positive electrode, and in the first cycle, the battery was subjected to constant current charging at a charging rate of 0.05 C with a cutoff value of 3.9 V for 2 hours and
subjected to constant current discharging at a discharging rate of 0.05 C with a cutoff value of 2.0 V for 1 hour.

Next, the charging and discharging rates were increased in increments of 0.05 C, the same charging and discharging were performed, and the rate at which charging and discharging could be performed without exceeding the cutoff value was defined as the rate characteristic.

### Evaluation of Strength at High Temperatures

The prototype secondary batteries were subjected to an impact using a thin film impact test machine QC-633(commercially available from Cometech Testing MAchines) in an environment of 25° C., with an impact tip diameter Φ of 38.1 mm, a load of 120 g, a height of 150 mm, and a single impact repetition, and a battery short-circuiting test was then performed using a tester. Five batteries were produced for each example, a total of five impact tests were performed, and the number of batteries in which short-circuiting occurred was counted.

Next, the impact test machine and the secondary batteries were put into an environmental test machine set to 60° C., and left for 2 hours, the same test was then performed, and the number of batteries in which short-circuiting occurred in the high-temperature test was counted.

### Evaluation of Occurrence of Short-Circuiting

The prototype secondary batteries were subjected to repeated charging and discharging evaluation in an environment of 40° C. Charging was performed at a charging rate of 0.05 C and a charging voltage of 4.0 V, and discharging was performed at a discharging rate of 0.05 C and a discharging voltage of 3.0 V. The number of cycles until abnormal voltage behavior occurred during charging and discharging was counted.

Next, the electrodes were removed from the evaluated batteries, and the presence of dendrites on the surface was observed using a digital microscope VHX-5000 (commercially available from Keyence Corporation) with 50× and 500× objective lenses.

### Examples 2 to 32

Polymer electrolytes and secondary batteries according to Examples 2 to 32 were produced in the same manner as in Example 1 except that the types and formulation amounts of polyether mono(meth)acrylate, polyether di(meth)acrylate, ionic compounds, and supporting electrolytes were changed as shown in Table 3.

TABLE 3

| | Polyether | | Polyether di(meth)acrylate | | | | Supporting | |
|---|---|---|---|---|---|---|---|---|
| | mono(meth)acrylate | | or tri(meth)acrylate | | Reactive ion | | electrolyte | |
| | | Parts | | Parts | | Parts | | Parts |
| | No. | by mass | No. | by mass | No. | by mass | No. | by mass |
| Example1 | M-230G | 50 | B-1 | 50 | C-3 | 5 | Li•TFSI | 20 |
| Example2 | A-1 | 50 | 14G | 50 | C-3 | 5 | Li•TFSI | 20 |
| Example3 | A-2 | 70 | B-2 | 30 | C-1 | 5 | Li•FSI | 20 |
| Example4 | AM-130G | 70 | B-2 | 30 | C-1 | 5 | Li•FSI | 20 |
| Example5 | A-3 | 90 | A-1000PER | 10 | C-1 | 5 | Li•FSI | 20 |
| Example6 | MEMA-4000 | 90 | A-1000PER | 10 | C-1 | 5 | Li•FSI | 20 |
| Example7 | A-4 | 90 | A-1000PER | 10 | C-1 | 5 | Li•FSI | 20 |
| Example8 | A-5 | 90 | A-1000PER | 10 | C-1 | 5 | Li•FSI | 20 |
| Example9 | A-6 | 90 | A-1000PER | 10 | C-1 | 5 | Li•FSI | 20 |
| Example10 | A-4 | 90 | A-1000PER | 10 | C-1 | 5 | Li•TFSI | 20 |
| Example11 | A-4 | 90 | A-1000PER | 10 | C-1 | 5 | Li•PF6 | 20 |
| Example12 | A-4 | 70 | B-3 | 30 | C-4 | 5 | Li•FSI | 20 |
| Example13 | AM-230G | 70 | A-1000PER | 30 | C-2 | 5 | Li•TFSI | 20 |
| Example14 | A-5 | 70 | A-1000PER | 30 | C-2 | 5 | Li•TFSI | 20 |
| Example15 | A-7 | 70 | A-1000PER | 30 | C-2 | 5 | Li•TFSI | 20 |
| Example16 | A-5 | 95 | B-4 | 5 | C-1 | 5 | Li•TFSI | 20 |
| Example17 | A-5 | 95 | B-3 | 5 | C-5 | 5 | Li•TFSI | 20 |
| Example18 | A-5 | 95 | B-5 | 5 | C-6 | 5 | Li•TFSI | 20 |
| Example19 | A-5 | 95 | A-1000 | 5 | C-7 | 5 | Li•TFSI | 20 |
| Example20 | A-5 | 95 | B-6 | 5 | C-8 | 5 | Li•TFSI | 20 |
| Example21 | AM-90G | 98 | A-400 | 2 | C-6 | 5 | Li•TFSI | 20 |
| Example22 | AM-130G | 98 | A-600 | 2 | C-6 | 5 | Li•TFSI | 20 |
| Example23 | A-5 | 98 | A-1000 | 2 | C-6 | 5 | Li•TFSI | 20 |
| Example24 | M-450G | 98 | PEGDA-4000 | 2 | C-6 | 5 | Li•TFSI | 20 |
| Example25 | A-4 | 95 | B-3 | 5 | C-1 | 5 | Li•TFSI | 5 |
| Example26 | A-4 | 95 | B-3 | 5 | C-1 | 5 | Li•TFSI | 10 |
| Example27 | A-4 | 95 | B-3 | 5 | C-1 | 5 | Li•TFSI | 15 |
| Example28 | A-4 | 95 | B-3 | 5 | C-1 | 5 | Li•TFSI | 20 |
| Example29 | A-4 | 95 | B-3 | 5 | C-1 | 3 | Li•TFSI | 20 |
| Example30 | A-4 | 95 | B-3 | 5 | C-1 | 1 | Li•TFSI | 20 |
| Example31 | A-9 | 98 | 9G | 2 | C-3 | 1 | Li•TFSI | 20 |
| Example32 | A-8 | 98 | A-GLY-20E | 2 | C-3 | 1 | Li•TFSI | 20 |

The structures when the materials used were polymerized are as follows.
M-230G (methoxypolyethyleneglycol methacrylate, in Formula (1-1), R1: methyl group, R2: ethylene group —(CH₂)₂—, R3: methyl group, m1: 23, n1: 0)
AM-130G (methoxypolyethylene glycol #600 acrylate, in Formula (1-1), Ri: hydrogen atom, R2: ethylene group, R3: methyl group, m1:13, n1: 0) AM-230G (methoxypolyethylene glycol #1000 acrylate, in Formula (1-1), R1: hydrogen atom, R2: ethylene group, R3: methyl group, m1: 23, n1: 0)
AM-90G (methoxypolyethylene glycol #400 acrylate, in Formula (1-1), R1: hydrogen atom, R2: ethylene group, R3: methyl group, m1: 9, n1: 0)
M-450G (methoxypolyethyleneglycol methacrylate, in Formula (1-1), R1: methyl group, R2: ethylene group, R3: methyl group, m1: 45, n1: 0)

A-1000PER (in Formula (2-1), R4: hydrogen atom, R5: ethylene group or propylene group, R6: ethylene group or propylene group, m2: 17, n2: 4)
A-1000 (polyethylene glycol #1000 diacrylate, in Formula (2-1), R4: hydrogen atom, R5: ethylene group, R6: ethylene group, m2: 23, n2: 0)
A-400 (polyethylene glycol #400 diacrylate, in Formula (2-1), R4: hydrogen atom, R5: ethylene group, R6: ethylene group, m2: 9, n2: 0)
A-600 (polyethylene glycol #600 diacrylate, in Formula (2-1), R4: hydrogen atom, R5: ethylene group, R6: ethylene group, m2: 14, n2: 0)

A-GLY-20E (ethoxylated glycerin triacrylate, in Formula (3-1), R7: hydrogen atom, R8: ethylene group, R9: ethylene group, R10: ethylene group, R11: —CH2(CH—)CH2-, m3: 20 as the sum of Formula (3-1), n3: 0)
9G: polyethylene glycol #400 dimethacrylate (in Formula (2-1), R4: methyl group, R5: ethylene group, R6: ethylene group, m2: 9, n2: 0)
14G: polyethylene glycol #600 dimethacrylate (in Formula (2-1), R4: methyl group, R5: ethylene group, R6: ethylene group, m2: 14, n2: 0)

All of the above materials are commercially available from Shin-Nakamura Chemical Co., Ltd.

MEMA-4000: (polyethylene glycol #4000 dimethacrylate (in Formula (2-1), R4: methyl group, R5: ethylene group, R6: ethylene group, m2: 90, n2: 0)) commercially available from TOHO Chemical Industry Co., Ltd.
PEGDA-4000: (polyethylene glycol diacrylate, in Formula (2-1), R4: hydrogen atom, R5: ethylene group, R6: ethylene group, m2: 90, n2: 0) commercially available from Sun Techno Chemical Co., Ltd.

Li TFSI indicates (lithium bis(trifluoromethanesulfonyl)imide).

Li FSI indicates (lithium bis(fluorosulfonyl)imide).

Li PF6 indicates (lithium hexafluorophosphate).

2. Onfiguration in which the Polymer Electrolyte of the Present Disclosure was Used as a Positive Electrode Active Material Binder

### Example 33

### Production of Negative Electrode

A 20 mm×20 mm lithium foil with a thickness of 60 m (commercially available from Honjo Metal Co., Ltd.) was laminated on a 20 mm×30 mm copper foil with a thickness of 20 μm, leaving a 10 mm non-laminated end on one side, and press-bonding was performed to produce a negative electrode. The total thickness of the produced negative electrode was 70 μm. In the negative electrode, a nickel-plated copper tab with a width of 5 mm was bonded to the one-side non-laminated end.

### Solid Electrolyte

A 20 mm×20 mm sheet with a thickness of 0.18 mm, LICGC (commercially available from Ohara Inc.), was used.

### Production of Positive Electrode

100 parts by mass of lithium cobalt oxide (commercially available from FUJIFILM Wako Pure Chemical Corporation), 18 parts by mass of the electrolyte solution (a solid content of 60%) of Example 1 as an active material binder, and 5 parts by mass of Denka Black Li-100 (commercially available from Denka Co., Ltd.) as a conductivity aid were mixed, 40 parts by mass of N-methylpyrrolidone was added, and the mixture was mixed and stirred. Next, the obtained slurry was applied onto a 15 mm×25 mm rolled aluminum foil with a thickness of 20 μm, leaving a 10 mm non-coated end on one side, and dried at 100° C. for 30 minutes, UV light was then emitted to the film surface using a high-pressure mercury UV radiation device (product name: Handy 1000, commercially available from Marionetwork) so that the cumulative light dose was 7,000 mJ/cm², and curing was performed. After curing, pressing was performed to obtain a positive electrode with a thickness of 80 μm. In the positive electrode, an aluminum tab with a width of 5 mm was bonded to the one-side non-coated end.

### Production of Secondary Battery Using Polymer Electrolyte as Positive Electrode Active Material Binder

A positive electrode in which the polymer electrolyte was used as an active material binder was vacuum-dried at 80° C. for 48 hours. Then, the polymer electrolyte film was put into a glove box (a temperature of 25° C. and a dew point of −70° C.) purged with argon, and the positive electrode/solid electrolyte/negative electrode were laminated in that order. The laminate was inserted into the aluminum laminate film and vacuum-packed to obtain a secondary battery in which the polymer electrolyte of the present disclosure was used as the positive electrode active material binder according to Example 33.

### Examples 34 to 36

Secondary batteries according to Examples 34 to 36 were produced in the same manner as in Example 33 except that the electrolyte solutions (polymer electrolyte) were changed as shown in Table 7. The evaluation results such as the rate characteristic are shown in Table 7.

3. Configuration in which the Polymer Electrolyte of the Present Disclosure was Used as a Bulk Electrolyte, a Positive Electrode Active Material Binder and a Negative Electrode Active Material Binder

### Example 37

### Production of Negative Electrode

100 parts by mass of graphite powder (commercially available from FUJIFILM Wako Pure Chemical Corporation), 20 parts by mass of the electrolyte solution (a solid content of 60%) of Example 1 as an active material binder, and 5 parts by mass of Denka Black Li-100 (commercially available from Denka Co., Ltd.) as a conductivity aid were mixed, 80 parts by mass of N-methylpyrrolidone was added, and the mixture was mixed and stirred. Next, the obtained slurry was applied onto a 20 mm×30 mm copper foil with a thickness of 20 μm, leaving a 10 mm non-coated end on one side, and dried at 100° C. for 30 minutes, UV light was then emitted to the film surface using a high-pressure mercury UV radiation device (product name: Handy 1000, commercially available from Marionetwork) so that the cumulative light dose was 8,000 mJ/cm², and curing was performed. After curing, pressing was performed to obtain a negative electrode with a thickness of 80 μm. At both ends, a negative electrode active material non-coated part where no negative electrode active material was applied to either side was provided, and a nickel-plated copper current collecting tab with a width of 5 mm was bonded to one negative electrode active material non-coated part.

### Production of Positive Electrode

100 parts by mass of lithium cobalt oxide (commercially available from FUJIFILM Wako Pure Chemical Corporation), 18 parts by mass of the electrolyte solution (a solid content of 60%) of Example 1 as an active material binder, and 5 parts by mass of Denka Black Li-100 (commercially available from Denka Co., Ltd.) as a conductivity aid were mixed, 40 parts by mass of N-methylpyrrolidone was added, and the mixture was mixed and stirred. Next, the obtained slurry was applied onto a rolled aluminum foil with a thickness of 20 m and dried at 60° C. for 30 minutes, UV light was then emitted to the film surface using a high-pressure mercury UV radiation device (product name: Handy 1000, commercially available from Marionetwork) so that the cumulative light dose was 7,000 mJ/cm², and curing was performed. After curing, pressing was performed to obtain a positive electrode with a thickness of 80 μm. At both ends, a positive electrode active material non-coated part where no positive electrode active material was applied to either side was provided, and an aluminum current collecting tab with a width of 5 mm was bonded to one positive electrode active material non-coated part.

### Formation of Polymer Electrolyte Layer

The electrolyte solution of Example 1 was applied to the obtained positive electrode using a bar coater, air-dried at 23° C. for 10 minutes, and then dried at 60° C. for 30 minutes. Next, UV light was emitted to the film surface using a high-pressure mercury UV radiation device (product name: Handy 1000, commercially available from Marionetwork) so that the cumulative light dose was 5,000 mJ/cm², and curing was performed. The film thickness after curing was 60 μm.

### Production of Secondary Battery Using Polymer Electrolyte as Bulk Electrolyte, Positive Electrode Active Material Binder and Negative Electrode Active Material Binder

The positive electrode and the negative electrode coated with the polymer electrolyte were vacuum-dried at 80° C. for 48 hours. Then, the polymer electrolyte film was put into a glove box (a temperature of 25° C. and a dew point of −70° C.) purged with argon, and a polyimide sheet punched into a window frame shape was attached to cover the outer peripheral part of the positive electrode surface to form a short-circuiting prevention layer. Next, lamination was performed so that the polymer electrolyte layer of the positive electrode coated with the polymer electrolyte corresponded to the active material layer of the negative electrode. The laminate was inserted into the aluminum laminate film and vacuum-packed to obtain a secondary battery according to Example 40 in which the polymer electrolyte of the present disclosure was used as the bulk electrolyte, the positive electrode active material binder and the negative electrode active material binder.

### Examples 38 to 40

Secondary batteries according to Examples 38 to 40 were produced in the same manner as in Example 37 except that the electrolyte solutions (polymer electrolyte) were changed as shown in Table 7. The evaluation results such as the rate characteristic are shown in Table 7.

### COMPARATIVE EXAMPLE

### Comparative Example 1

As polymer electrolyte materials, the following materials were mixed and stirred.
Polyether monomethacrylate NK-ester M-40G (commercially available from Shin-Nakamura Chemical Co., Ltd.): 70 parts by mass
Polyether dimethacrylate 4G (commercially available from Shin-Nakamura Chemical Co., Ltd.): 30 parts by mass
Lithium bis(trifluoromethanesulfonyl)imide (commercially available from Kishida Chemical Co., Ltd.): 10.0 parts by mass
Initiator Omnirad184 (commercially available from IGM RESINS B.V.): 2.0 parts by mass

Next, methyl ethyl ketone was added so that the total solid content was 60 mass %, and the mixture was then mixed by motor stirring to prepare an electrolyte solution.

Next, a polymer electrolyte and a secondary battery according to Comparative Example 1 were produced in the same manner as in Example 1.

### Comparative Examples 2 to 6

Polymer electrolytes and secondary batteries according to Comparative Examples 2 to 6 were produced in the same manner as in Example 1 except that the types and formulation amounts of polyether mono(meth)acrylate, polyether di(meth)acrylate, ionic compounds, and supporting electrolytes were changed as shown in Table 4.

The secondary batteries according to Comparative Examples 1 to 6 had a configuration in which the polymer electrolyte was used as a bulk electrolyte. The evaluation results such as the rate characteristic are shown in Table 6.

TABLE 4

| | Polyether | | Polyether di(meth)acrylate | | | | Supporting | |
|---|---|---|---|---|---|---|---|---|
| | mono(meth)acrylate | | or tri(meth)acrylate | | Reactive ion | | electrolyte | |
| | | Parts | | Parts | | Parts | | Parts |
| | No. | by mass | No. | by mass | No. | by mass | No. | by mass |
| Comparative Example1 | M-40G | 70 | 4G | 30 | — | — | Li•TFSI | 10 |
| Comparative Example2 | — | — | 4G | 100 | C-1 | 15 | Li•TFSI | 10 |
| Comparative Example3 | M-40G | 30 | 4G | 70 | C-1 | 15 | Li•FSI | 10 |
| Comparative Example4 | AM-130G | 99 | A-600 | 1 | C-2 | 15 | Li•FSI | 10 |
| Comparative Example5 | AM-90G | 100 | — | — | C-2 | 15 | Li•FSI | 10 |
| Comparative Example6 | PA-500 | 70 | APG-400 | 30 | C-2 | 15 | Li•FSI | 10 |

The structures when the materials used were polymerized are as follows.
M-40G: methoxytetraethylene glycol methacrylate (in Formula (1-1), R1: methyl group, R2: ethylene group, R3: methyl group, m1: 3, n1: 0
4G: polyethylene glycol #200 dimethacrylate (in Formula (2-1), R4: methyl group, R5: ethylene group, R6: ethylene group, m2: 4, n2: 0)
APG-400: polypropylene glycol #400 diacrylate (in Formula (2-1), R4: hydrogen atom,
R5: propylene group, R6: propylene group, m2: 0, n2: 7) AM-90G, AM-130G, and A-600 are as described above.

All of the above materials are commercially available from Shin-Nakamura Chemical Co., Ltd.
PA-500: hydroxypolypropylene glycol monoacrylate (in Formula (1-1), R1: hydrogen atom, R2: propylene group, R3: hydroxyl group, m1: 0, n1: 5) commercially available from TOHO Chemical Industry Co., Ltd.

### Comparative Example 7

A secondary battery according to Comparative Example 7 was produced in the same manner as in Example 33 except that 7 parts by mass of Kureha KF Polymer L #1120 (commercially available from Kureha Corporation) was used as the positive electrode active material binder.

### Comparative Examples 8 to 10

Secondary batteries according to Comparative Examples 8 to 10 were produced in the same manner as in Example 33 except that the types and formulation amounts of polyether mono(meth)acrylate, polyether di(meth)acrylate, ionic compounds, and supporting electrolytes were changed as shown in Table 8.

The secondary batteries according to Comparative Examples 7 to 10 had a configuration in which the polymer electrolyte was used as a positive electrode active material binder. The evaluation results such as the rate characteristic are shown in Table 8.

### Comparative Examples 11 to 14

Secondary batteries according to Comparative Examples 11 to 14 were produced in the same manner as in Example 37 except that the types and formulation amounts of polyether mono(meth)acrylate, polyether di(meth)acrylate, ionic compounds, and supporting electrolytes were changed as shown in Table 8.

The secondary batteries according to Comparative Examples 11 to 14 had a configuration in which the polymer electrolyte was used as a positive electrode active material binder, a bulk electrolyte, and a negative electrode active material binder. The evaluation results such as the rate characteristic are shown in Table 8.

The obtained polymer electrolytes and secondary batteries according to Examples 1 to 40 and Comparative Examples 1 to 14 were evaluated in the same manner as in Example 1. The evaluation results are shown in Tables 5-1 and 5-2, Table 6, Table 7, and Table 8.

TABLE 5-1

| | Volume | Average number | | | | Ionic conductivity | |
|---|---|---|---|---|---|---|---|
| | swelling | of moles added | | | Ion ratio | (S/cm) | |
| | ratio (%) | Meo | Mpo | Mpo % | A/(A + B) | 25 °C | 5 °C |
| Example1 | 42 | 44 | 7 | 16 | 0.80 | 6.35 × 10⁻⁶ | 5.24 × 10⁻⁷ |
| Example2 | 45 | 41 | 7 | 16 | 0.80 | 1.41 × 10⁻⁵ | 2.16 × 10⁻⁶ |
| Example3 | 71 | 78 | 6 | 8 | 0.80 | 7.13 × 10⁻⁵ | 6.11 × 10⁻⁵ |
| Example4 | 65 | 28 | 4 | 14 | 0.80 | 6.63 × 10⁻⁵ | 9.89 × 10⁻⁶ |
| Example5 | 84 | 74 | 14 | 19 | 0.80 | 6.28 × 10⁻⁵ | 2.71 × 10⁻⁵ |
| Example6 | 80 | 76 | 0 | 0 | 0.80 | 8.72 × 10⁻⁵ | 1.98 × 10⁻⁵ |
| Example7 | 79 | 30 | 6 | 20 | 0.80 | 9.11 × 10⁻⁵ | 4.12 × 10⁻⁵ |
| Example8 | 73 | 16 | 3 | 18 | 0.80 | 4.01 × 10⁻⁵ | 1.13 × 10⁻⁵ |
| Example9 | 76 | 7 | 1 | 17 | 0.80 | 2.97 × 10⁻⁵ | 7.90 × 10⁻⁶ |
| Example10 | 79 | 30 | 6 | 20 | 0.80 | 8.87 × 10⁻⁵ | 3.12 × 10⁻⁵ |
| Example11 | 79 | 30 | 6 | 20 | 0.80 | 8.68 × 10⁻⁵ | 3.52 × 10⁻⁵ |
| Example12 | 50 | 34 | 6 | 19 | 0.80 | 3.92 × 10⁻⁵ | 6.86 × 10⁻⁶ |
| Example13 | 51 | 21 | 0 | 1 | 0.80 | 1.69 × 10⁻⁵ | 3.04 × 10⁻⁶ |
| Example14 | 52 | 16 | 3 | 18 | 0.80 | 1.86 × 10⁻⁵ | 3.11 × 10⁻⁶ |
| Example15 | 49 | 11 | 7 | 68 | 0.80 | 1.42 × 10⁻⁵ | 3.62 × 10⁻⁶ |
| Example16 | 93 | 16 | 3 | 18 | 0.80 | 4.25 × 10⁻⁵ | 4.99 × 10⁻⁶ |
| Example17 | 104 | 17 | 3 | 16 | 0.80 | 7.45 × 10⁻⁵ | 3.14 × 10⁻⁶ |
| Example18 | 113 | 20 | 3 | 16 | 0.80 | 6.01 × 10⁻⁵ | 4.27 × 10⁻⁶ |
| Example19 | 94 | 16 | 3 | 16 | 0.80 | 1.69 × 10⁻⁵ | 5.00 × 10⁻⁶ |
| Example20 | 95 | 16 | 3 | 20 | 0.80 | 3.42 × 10⁻⁵ | 7.53 × 10⁻⁶ |
| Example21 | 112 | 9 | 0 | 0 | 0.80 | 2.63 × 10⁻⁶ | 8.61 × 10⁻⁷ |
| Example22 | 115 | 13 | 0 | 0 | 0.80 | 5.76 × 10⁻⁶ | 2.63 × 10⁻⁶ |
| Example23 | 111 | 17 | 3 | 17 | 0.80 | 8.97 × 10⁻⁶ | 5.49 × 10⁻⁶ |
| Example24 | 109 | 45 | 0 | 0 | 0.80 | 8.44 × 10⁻⁶ | 4.18 × 10⁻⁶ |
| Example25 | 104 | 34 | 6 | 19 | 0.50 | 6.12 × 10⁻⁵ | 1.77 × 10⁻⁵ |
| Example26 | 104 | 34 | 6 | 19 | 0.67 | 7.92 × 10⁻⁵ | 2.56 × 10⁻⁵ |
| Example27 | 103 | 34 | 6 | 19 | 0.75 | 1.13 × 10⁻⁴ | 6.75 × 10⁻⁵ |
| Example28 | 104 | 34 | 6 | 19 | 0.80 | 3.12 × 10⁻⁴ | 8.99 × 10⁻⁵ |
| Example29 | 106 | 34 | 6 | 19 | 0.87 | 1.57 × 10⁻⁴ | 6.86 × 10⁻⁵ |
| Example30 | 105 | 34 | 6 | 19 | 0.95 | 6.93 × 10⁻⁵ | 1.01 × 10⁻⁵ |
| Example31 | 116 | 4 | 3 | 72 | 0.95 | 1.55 × 10⁻⁶ | 4.70 × 10⁻⁷ |
| Example32 | 110 | 11 | 8 | 72 | 0.95 | 1.73 × 10⁻⁶ | 4.40 × 10⁻⁷ |

TABLE 5-2

| | | | Impact resistance test | | | |
|---|---|---|---|---|---|---|
| | | | Number of short- | | | |
| | Rate characteristic | | circuiting occurrences | | Short-circuiting occurrence evaluation | |
| | During | During | in secondary battery | | Number of | |
| | charging | discharging | 25 °C | 60 °C | cycles | Electrode surface |
| Example1 | 0.15 C | 0.15 C | 0/5 | 0/5 | 62 | Small protrusions observed |
| Example2 | 0.20 C | 0.20 C | 0/5 | 1/5 | 68 | Small protrusions observed |
| Example3 | 0.20 C | 0.15 C | 0/5 | 0/5 | 88 | Small protrusions observed |
| Example4 | 0.20 C | 0.20 C | 0/5 | 0/5 | 84 | Small protrusions observed |
| Example5 | 0.20 C | 0.20 C | 0/5 | 0/5 | >100 | Almost smooth |
| Example6 | 0.20 C | 0.20 C | 0/5 | 0/5 | >100 | Almost smooth |
| Example7 | 0.20 C | 0.20 C | 0/5 | 0/5 | >100 | Almost smooth |
| Example8 | 0.20 C | 0.20 C | 0/5 | 0/5 | >100 | Almost smooth |
| Example9 | 0.20 C | 0.20 C | 0/5 | 0/5 | >100 | Almost smooth |
| Example10 | 0.20 C | 0.20 C | 0/5 | 0/5 | >100 | Almost smooth |
| Example11 | 0.20 C | 0.20 C | 0/5 | 0/5 | >100 | Almost smooth |
| Example12 | 0.20 C | 0.20 C | 0/5 | 0/5 | >100 | Very small protrusions observed |
| Example13 | 0.20 C | 0.20 C | 0/5 | 0/5 | >100 | Almost smooth |
| Example14 | 0.20 C | 0.20 C | 0/5 | 0/5 | >100 | Very small protrusions observed |
| Example15 | 0.20 C | 0.20 C | 0/5 | 0/5 | >100 | Almost smooth |
| Example16 | 0.20 C | 0.25 C | 0/5 | 0/5 | >100 | Almost smooth |
| Example17 | 0.20 C | 0.20 C | 0/5 | 0/5 | >100 | Almost smooth |
| Example18 | 0.20 C | 0.20 C | 0/5 | 0/5 | >100 | Almost smooth |
| Example19 | 0.20 C | 0.20 C | 0/5 | 0/5 | >100 | Almost smooth |
| Example20 | 0.20 C | 0.20 C | 0/5 | 0/5 | >100 | Almost smooth |
| Example21 | 0.15 C | 0.15 C | 0/5 | 0/5 | >100 | Very small protrusions observed |
| Example22 | 0.20 C | 0.20 C | 0/5 | 0/5 | >100 | Almost smooth |
| Example23 | 0.20 C | 0.20 C | 0/5 | 0/5 | >100 | Almost smooth |
| Example24 | 0.20 C | 0.20 C | 0/5 | 0/5 | >100 | Almost smooth |
| Example25 | 0.25 C | 0.25 C | 0/5 | 0/5 | >100 | Almost smooth |
| Example26 | 0.30 C | 0.25 C | 0/5 | 0/5 | >100 | Almost smooth |
| Example27 | 0.45 C | 0.40 C | 0/5 | 0/5 | >100 | Almost smooth |
| Example28 | 0.50 C | 0.45 C | 0/5 | 0/5 | >100 | Almost smooth |
| Example29 | 0.45 C | 0.40 C | 0/5 | 0/5 | >100 | Almost smooth |
| Example30 | 0.30 C | 0.25 C | 0/5 | 0/5 | >100 | Almost smooth |
| Example31 | 0.15 C | 0.15 C | 0/5 | 1/5 | >100 | Almost smooth |
| Example32 | 0.15 C | 0.20 C | 0/5 | 1/5 | >100 | Almost smooth |

In Tables 5-1, 5-2, and 6, Mpo % is the ratio of the average number of moles added Mpo to the average number of moles added Meo.

TABLE 6

| | Volume | Average number | | | | Ionic conductivity | |
|---|---|---|---|---|---|---|---|
| | swelling | of moles added | | | Ion ratio | (S/cm) | |
| | ratio (%) | Meo | Mpo | Mpo % | A/A + B) | 25 °C | 5 °C |
| Comparative Example1 | 56 | 3 | 0 | 0 | — | 6.82 × 10⁻⁷ | 7.86 × 10⁻⁸ |
| Comparative Example2 | 28 | 3 | 0 | 0 | 0.40 | 8.17 × 10⁻⁷ | 6.60 × 10⁻⁸ |
| Comparative Example3 | 29 | 3 | 0 | 0 | 0.40 | 6.54 × 10⁻⁷ | 6.25 × 10⁻⁸ |
| Comparative Example4 | 148 | 13 | 0 | 0 | 0.40 | 4.64 × 10⁻⁵ | 9.41 × 10⁻⁷ |
| Comparative Example5 | —(Dissolved) | 9 | 0 | 0 | 0.40 | 3.15 × 10⁻⁵ | 2.03 × 10⁻⁷ |
| Comparative Example6 | 58 | 0 | 6 | — | 0.40 | 1.83 × 10⁻⁷ | 8.93 × 10⁻⁸ |

| | | | Impact resistance test | | | |
|---|---|---|---|---|---|---|
| | Rate | | Number of short- | | Short-circuiting | |
| | characteristic | | circuiting occurrences | | occurrence evaluation | |
| | During | During | in secondary battery | | Number | |
| | charging | discharging | 25 °C | 60 °C | of cycles | Electrode surface |
| Comparative Example1 | 0.05 C | 0.05 C | 0/5 | 0/5 | 48 | Small dendrites observed |
| Comparative Example2 | 0.05 C> | — | 0/5 | 0/5 | 20 | Dendrites observed |
| Comparative Example3 | 0.05 C | 0.05 C | 0/5 | 0/5 | 20 | Dendrites observed |
| Comparative Example4 | 0.20 C | 0.20 C | 0/5 | 4/5 | 17 | Dendrites observed |
| Comparative Example5 | 0.20 C | 0.20 C | 0/5 | 5/5 | 20 | Dendrites observed |
| Comparative Example6 | 0.05 C> | — | 0/5 | 0/5 | 23 | Dendrites observed |

The polymer electrolytes according to Examples 1 to 32 had a polymer structure including the structure of Formula (4) in addition to the structure of Formula (1) and at least one of the structures of Formulae (2) and (3), and the volume swelling ratio was 3000 to 12000. Therefore, they exhibited high ionic conductivity at both 25° C. and 5° C. In addition, the secondary batteries in which the polymer electrolyte according to Examples 1 to 32 was used as the bulk electrolyte had both a high rate characteristic and a high impact resistance at high temperatures.

In addition, in the polymer electrolytes according to Examples 1 to 32, the volume swelling ratio was 300% to 120% and A/(A+B) was 0.50 or more. Therefore, the number of cycles until short-circuiting occurred was large and the lifespan of the secondary batteries was prolonged.

In addition, examples including Example 7 in which the mass ratio α:β of the content A of the structure of Formula (1) to the content B of the structure of Formula (2) in the polymer structure was 70:30 to 98:2, m1+n1 in Formula (1-1) was 14 to 58, and m2+n2 in Formula (2-1) was 14 to 58 exhibited particularly high ionic conductivity, and also favorable rate characteristics of the secondary batteries.

On the other hand, the polymer electrolytes according to Comparative Example 1 having no structure of Formula (4) in the polymer structure, Comparative Examples 2 and 6 having no structure of Formula (1), and Comparative Example 3 having a volume swelling ratio of less than 30% exhibited low ionic conductivity and the results of the rate characteristics of the secondary batteries were very low. In addition, in Comparative Examples 2 to 6 in which A/(A+B) was less than 0.50, the number of cycles until short-circuiting occurred was small and dendrites on the surface of the battery electrode were observed.

In addition, the secondary batteries using the polymer electrolytes according to Comparative Examples 4 and 5 in which the volume swelling ratio was more than 120% or there were no 3D crosslinks exhibited a significant decrease in impact resistance at high temperatures.

TABLE 7

| | | | | | Impact resistance test | |
|---|---|---|---|---|---|---|
| | | | | | Number of short- | |
| | | | Rate characteristic | | circuiting occurrences | |
| | Polymer | Polymer electrolyte | During | During | in secondary battery | |
| | electrolyte | applied part | charging | discharging | 25 °C | 60 °C |
| Example33 | Same as Example1 | Positive electrode | 0.15 C | 0.15 C | 0/5 | 0/5 |
| Example34 | Same as Example7 | active material binder | 0.20 C | 0.20 C | 0/5 | 0/5 |
| Example35 | Same as Example12 | | 0.20 C | 0.20 C | 0/5 | 0/5 |
| Example36 | Same as Example29 | | 0.45 C | 0.40 C | 0/5 | 0/5 |
| Example37 | Same as Example1 | Bulk electrolyte | 0.15 C | 0.15 C | 0/5 | 0/5 |
| Example38 | Same as Example7 | Positive electrode | 0.20 C | 0.20 C | 0/5 | 0/5 |
| Example39 | Same as Example12 | active material binder | 0.20 C | 0.20 C | 0/5 | 0/5 |
| Example40 | Same as Example29 | Negative electrode | 0.45 C | 0.40 C | 0/5 | 0/5 |
| | | active material binder | | | | |

TABLE 8

| | | | | | Impact resistance test | |
|---|---|---|---|---|---|---|
| | | | | | Number of short- | |
| | | | Rate characteristic | | circuiting occurrences | |
| | | Polymer electrolyte | During | During | in secondary battery | |
| | Polymer electrolyte | applied part | charging | discharging | 25 °C | 60 °C |
| Comparative | — (KF Polymer L#1120) | Positive electrode | 0.05 C> | — | 0/5 | 0/5 |
| Example7 | | active material binder | | | | |
| Comparative | Same as | | 0.05 C | 0.05 C | 0/5 | 0/5 |
| Example8 | Comparative Example1 | | | | | |
| Comparative | Same as | | 0.05 C | 0.05 C | 0/5 | 0/5 |
| Example9 | Comparative Example2 | | | | | |
| Comparative | Same as | | 0.05 C | 0.05 C | 0/5 | 0/5 |
| Example 10 | Comparative Example6 | | | | | |
| Comparative | Same as | Bulk electrolyte | 0.05 C> | — | 0/5 | 0/5 |
| Example11 | Comparative Example1 | Positive electrode | | | | |
| Comparative | Same as | active material binder | 0.05 C> | — | 0/5 | 0/5 |
| Example 12 | Comparative Example3 | Negative electrode | | | | |
| Comparative | Same as | active material binder | 0.25 C | 0.20 C | 0/5 | 5/5 |
| Example 13 | Comparative Example4 | | | | | |
| Comparative | Same as | | 0.25 C | 0.20 C | 0/5 | 5/5 |
| Example14 | Comparative Example5 | | | | | |

Similarly to the case in which the polymer electrolyte was used as the bulk electrolyte, the secondary batteries according to Examples 33 to 36 in which the polymer electrolyte of the present disclosure was used as the positive electrode active material binder and the secondary batteries according to Examples 37 to 40 in which the polymer electrolyte was used as the positive electrode active material binder, the bulk electrolyte, and the negative electrode active material binder had both a high rate characteristic and a high impact resistance at high temperatures.

On the other hand, the secondary batteries according to Comparative Examples 8 and 11 having no structure of Formula (4) in the polymer structure, Comparative Examples 9 and 10 having no structure of Formula (1), and Comparative Example 12 in which the volume swelling ratio was less than 3000 exhibited a low rate characteristic result. In addition, the secondary batteries according to Comparative Examples 13 and 14 in which the volume swelling ratio was more than 120 or there were no 3D crosslinks exhibited a significant decrease in impact resistance at high temperatures.

According to at least one aspect of the present disclosure, it is possible to obtain a polymer electrolyte which exhibits high mechanical strength even at high temperatures, and high ionic conductivity, and can minimize the occurrence of dendrites at the interface between a polymer electrolyte and a battery negative electrode. In addition, according to at least one aspect of the present disclosure, it is possible to obtain a secondary battery having high impact resistance even in a high temperature environment and excellent battery performance.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A polymer electrolyte,
wherein the polymer electrolyte comprises a polymer and an alkali metal salt,
the alkali metal salt comprises an alkali metal salt comprising, as an anion, at least one selected from the group consisting of bis(trifluoromethanesulfonyl)imide, bis(fluorosulfonyl)imide and hexafluorophosphate,
the polymer has
a structure represented by the following Formula (1),
at least one structure selected from the group consisting of a structure represented by the following Formula (2) and a structure represented by the following Formula (3), and
a structure represented by the following Formula (4),
when the total number of moles of the anions in the alkali metal salt contained per unit mass of the polymer electrolyte is A, and the number of moles of sulfonylimide groups bonded to the polymer is B, A and B satisfy the relationship of the following Formula (X),
0.50≤A/(A+B) (X)
and the volume swelling ratio of the polymer electrolyte determined by a methyl ethyl ketone immersion method is 30% to 120%: 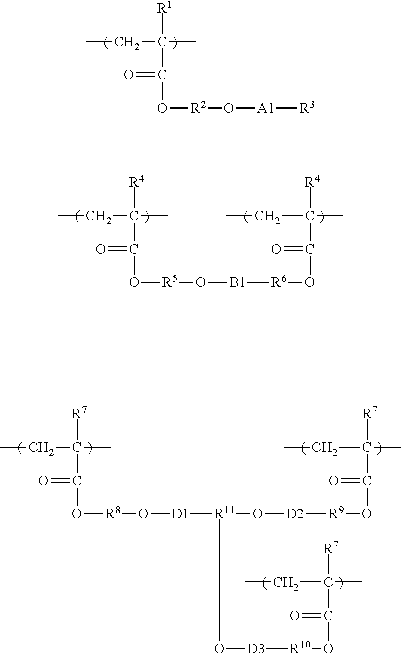
in Formula (1), R¹ is a hydrogen atom or a methyl group, R² is a linear or branched alkylene group having 1 to 6 carbon atoms, R³ is an alkyl group having 1 to 6 carbon atoms,
in Formula (2), R⁴'s are each independently a hydrogen atom or a methyl group, R⁵ and R⁶ are each independently a linear or branched alkylene group having 1 to 6 carbon atoms,
in Formula (3), R⁷'s are each independently a hydrogen atom or a methyl group, R⁸, R⁹ and R¹⁰ are each independently a linear or branched alkylene group having 1 to 6 carbon atoms, R¹¹ is a trivalent organic group having 1 to 6 carbon atoms,
in Formulae (1) to (3), A1, B1, D1, D2 and D3 are each independently a linking group having at least an ethylene oxide structure represented by (—CH₂CH₂—O—), 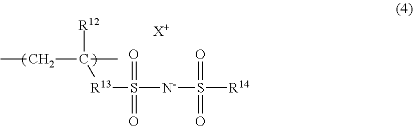
in Formula (4), R¹² is a hydrogen atom or a methyl group, R¹³ is a divalent linking group, R¹⁴ is a fluorine atom or a perfluoroalkyl group having 1 to 4 carbon atoms, X⁺ is at least one selected from the group consisting of a lithium ion, a sodium ion and a potassium ion,
the sulfonylimide group is a functional group represented by the following Formula (S), 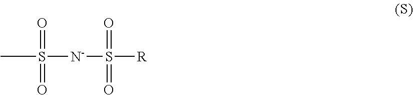
in Formula (S), R is a fluorine atom or a perfluoroalkyl group having 1 to 4 carbon atoms.

2. The polymer electrolyte according to claim 1, wherein A and B satisfy 0.65≤A/(A+B)≤0.96.

3. The polymer electrolyte according to claim 1, wherein the average number of moles added Meo of the ethylene oxide structure per mol of (meth)acryloyl residue in the polymer is 2.5 mol or more.

4. The polymer electrolyte according to claim 1, wherein A1, B1, D1, D2 and D3 each independently additionally have a propylene oxide structure represented by (—CH₂CH(CH₃)—O—).

5. The polymer electrolyte according to claim 4, wherein, in the polymer, the average number of moles added Mpo of the propylene oxide structure per mol of (meth)acryloyl residue is 5% to 25% of the average number of moles added Meo of the ethylene oxide structure per mol of (meth)acryloyl residue.

6. The polymer electrolyte according to claim 1, wherein, when the mass content of the structure represented by Formula (1) in the polymer comprised in the polymer electrolyte is α and the total mass content of the structure represented by Formula (2) and the structure represented by Formula (3) is β, the mass ratio α:β is 70:30 to 98:2.

7. The polymer electrolyte according to claim 1,
wherein the structure represented by Formula (1) is a structure represented by the following Formula (1-1),
the structure represented by Formula (2) is a structure represented by the following Formula (2-1), and
the structure represented by Formula (3) is a structure represented by the following Formula (3-1): 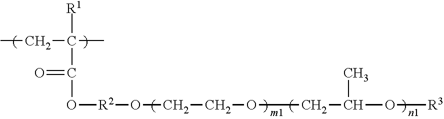
in Formula (1-1), R¹ is a hydrogen atom or a methyl group, R² is a linear or branched alkylene group having 1 to 6 carbon atoms, R³ is an alkyl group having 1 to 6 carbon atoms, m1 and n1 are an average number of moles added, m1 is an integer of 1 or more, n1 is an integer of 0 or more,
the arrangement of an ethylene oxide structure represented by (—CH₂—CH₂—O—) and a propylene oxide structure represented by (—CH₂—CH(CH₃)—O—) may be a block copolymer or a random copolymer, 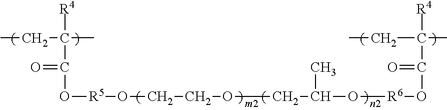
in Formula (2-1), R⁴'s are each independently a hydrogen atom or a methyl group, R⁵ and R⁶ are each independently a linear or branched alkylene group having 1 to 6 carbon atoms, m2 and n2 are an average number of moles added, m2 is an integer of 1 or more, n2 is an integer of 0 or more,
the arrangement of an ethylene oxide structure represented by (—CH₂—CH₂—O—) and a propylene oxide structure represented by (—CH₂—CH(CH₃)—O—) may be a block copolymer or a random copolymer,
the chain interposed between two —COO-'s may additionally have a diol structure having 1 to 6 carbon atoms, 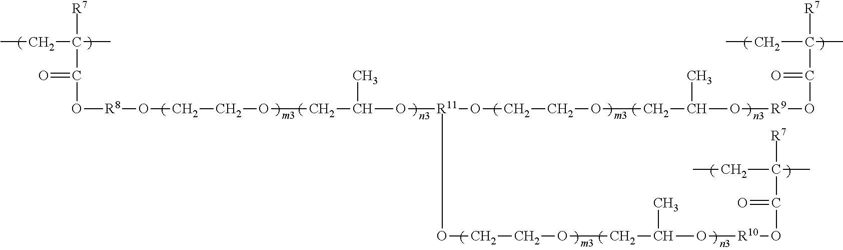
in Formula (3-1), R⁷'s are each independently a hydrogen atom or a methyl group, R⁸, R⁹, and R¹⁰ are each independently a linear or branched alkylene group having 1 to 6 carbon atoms, R¹¹ is a trivalent organic group having 1 to 6 carbon atoms, m3 and n3 are an average number of moles added, m3's are each independently an integer of 1 or more, n3's are each independently an integer of 0 or more,
the arrangement of an ethylene oxide structure represented by (—CH₂—CH₂—O—) and a propylene oxide structure represented by (—CH₂—CH(CH₃)—O—) may be a block copolymer or a random copolymer,
the chain interposed between —COO— and R¹¹ may additionally have a diol structure having 1 to 6 carbon atoms.

8. The polymer electrolyte according to claim 7, wherein, in the polymer electrolyte, m1+n1 in Formula (1-1) is 14 to 58, and
m2+n2 in Formula (2-1) and/or m3+n3 in Formula (3-1) are 14 to 58.

9. The polymer electrolyte according to claim 7, wherein, in the polymer electrolyte,
m1:n1 in Formula (1-1) is 80:20 to 95:5, and
m2:n2 in Formula (2-1) and/or m3:n3 in Formula (3-1) is 80:20 to 95:5.

10. The polymer electrolyte according to claim 1, wherein the content of the structure represented by Formula (4) in the polymer electrolyte with respect to a total content of 100 parts by mass of the structure represented by Formula (1), the structure represented by Formula (2) and the structure represented by Formula (3) is 1 to 25 parts by mass.

11. The polymer electrolyte according to claim 1, wherein the polymer electrolyte is a dry polymer electrolyte.

12. A secondary battery, comprising a positive electrode, a bulk electrolyte and a negative electrode,
wherein at least one selected from the group consisting of the positive electrode, the bulk electrolyte and the negative electrode comprises the polymer electrolyte according to claim 1.

13. A secondary battery, comprising a positive electrode, a bulk electrolyte and a negative electrode,
wherein the secondary battery satisfies at least one of the following (i) to (iii):
(i) the positive electrode comprises a positive electrode active material and a positive electrode active material binder that fixes the positive electrode active material, and the positive electrode active material binder is the polymer electrolyte according to claim 1,
(ii) the bulk electrolyte is the polymer electrolyte according to claim 1,
(iii) the negative electrode comprises a negative electrode active material and a negative electrode active material binder that fixes the negative electrode active material, and the negative electrode active material binder is the polymer electrolyte according to claim 1.
